(19) United States
(12) Patent Application Publication
(10) Pub. No.: US 2026/0146893 A1
(43) Pub. Date: May 28, 2026

(54) A METHOD AND AN APPARATUS FOR CONTACTLESSLY DETERMINING THE TEMPERATURE OF A STREAM OF CONVEYED MATERIAL AND GRANULATION DEVICE HAVING SUCH A CONTACTLESS TEMPERATURE DETERMINATION APPARATUS

(71) Applicant: MAAG Germany GmbH, Grossostheim (DE)

(72) Inventor: Eckhard Siegmann, Koln (DE)

(21) Appl. No.: 19/120,673

(22) PCT Filed: Oct. 9, 2023
(86) PCT No.: PCT/EP2023/077841

§ 371 Date: Feb. 9, 2026

(30) Foreign Application Priority Data
Oct. 13, 2022 (DE) 10 2022 126 635.4

(51) Int. Cl. G01J 5/00; B29B 9/06; G01J 5/061; G01J 5/80

(52) U.S. Cl. CPC G01J 5/0022; B29B 9/065; G01J 5/061; G01J 5/802

(57) ABSTRACT

A method and apparatus for contactlessly determining the temperature of stranded and/or granular objects in a stream of conveyed material, in which infrared sensors are used to capture the radiation field of the stream of conveyed material flowing past against a background, and the temperature of the stranded or granular objects is determined from the measurement signal from the infrared sensors, wherein the temperature of the background, against which the stream of conveyed material to be measured flows past, is varied in terms of time and/or location by means of a temperature control apparatus, wherein degrees of fluctuation are determined from the measurement signal from the infrared sensors for different background temperatures and the position of a minimum fluctuation is determined from these degrees of fluctuation, wherein the object temperature is determined from the value of the measurement signal at the time/location of the minimum fluctuation.

The present invention relates to a method and an apparatus for contactlessly determining the temperature of the strand-shaped and/or granule-shaped objects of a stream of conveyed material, wherein infrared sensors are used for the temperature determination in order to determine the temperature of the particles or strands of the stream of conveyed material. The invention also relates to the use of such a non-contact temperature determination device on a pelletizing apparatus, in particular at the outlet of a pellet dryer or a strand pelletizer of a granulation device.

For the processing of granules and their preliminary and intermediate products, precise temperature determination is as important as it is difficult. Since excessively high and low temperatures of the strands or granules to be processed lead to problems in the process, precise temperature determination is required, wherein the most accurate possible knowledge of the respective temperature is required at various points in order to be able to control the process in a targeted manner. Various control variables such as melt temperature, water temperatures, water velocities, air velocities, cooling water nozzle flow rates, surface-to-volume ratio of the granules or strands, dwell times and many more can be adjusted in upstream process sections in order to specifically change the temperature of the objects at the measuring point. Many of these control variables have linearizable correlations to the object temperature at operating points and it can be taken into account that changes only take effect at the measuring point after a certain delay. The actuating variables and response times are not a problem for temperature control. Sometimes it is not even necessary to control to a setpoint temperature, but rather to maintain a temperature window, as other important process variables also need to be controlled. Until now, however, the difficulty has been that without a reliable accurate temperature measurement value, temperature control to a temperature window is not possible, which this invention aims to change.

Pelletizing processes can be used to produce plastic pellets, usually by forcing a plastic melt through nozzle-like holes to produce strands of plastic material. Depending on the pelletizing technology, the resulting strands can be cut off directly at the outlet of a die plate by a knife rotating there, as is known in underwater pelletizing or dry pelletizing, wherein in underwater pelletizing the pellets or granules are dried in a downstream dryer. Alternatively, in strand pelletizing, the strands of plastic material can first be fed in strand form through a cooling section and then fed to a strand pelletizer, in which the strands are then cut into pellets between a stationary cutting strip and a rotating cutting rotor. However, such pelletizing processes are not only used for plastics or plastic melts, but also in the pharmaceutical sector for the production of tablets or pills, or also in the food sector. In order to achieve high-quality products, precise temperature control of the processed masses is required.

For example, the cutting quality can be impaired if the temperature or the cross-sectional temperature profile in the strands still to be pelletized is not correct, so that precise temperature determination of the plastic or material strands may also be required at different positions between the die plate and the strand pelletizer. Measurements of the longitudinal temperature gradient or temperature measurements in two or more evaluation portions along the course of the stream of conveyed material can be used to draw conclusions about the core condition of the strands, which must not consist of a hot low-viscosity melt for the cut. On the other hand, it can also lead to process problems after crushing if the temperature of the granules deviates too much from the specified temperature window. For example, crystallizable plastic pellets or granules require a determined temperature, which can be high enough to trigger an energy-efficient self-crystallization process by means of intrinsic heat, but must not be too high to prevent the plastic granules from sticking together. In particular, the pellets should have the predetermined temperature at the outlet of a pellet dryer before they are fed to a corresponding post-treatment line or station, such as a vibrating conveyor or into a reaction container.

However, determining the temperature of such strands and granules is also difficult for various reasons and has hardly been sufficiently accurate to date. On the one hand, this is due to the fundamental problem that the temperature is measured on the moving object. The strands of plastic material or granules move while the temperature is to be measured, wherein, for example, a leisurely, densely packed stream of granules does not flow past the outlet of a centrifugal dryer, but granules swirled by the air flow more or less fly past. Depending on the material, the pellets should remain fluidized during the temperature measurement process, otherwise agglomerates may form. This applies in particular to plastic pellets made of plastics that tend to be sticky, but can also be the case with pharmaceutical or food-grade pellets.

On the other hand, the strands and granules whose temperature is to be measured are often very small, so that the sensor system used would need a sensitive, highly dynamic response behavior in order to respond sufficiently to the correspondingly small amounts of heat or radiation emitted by the small objects, especially in view of the sometimes high speed at which granules flow past the sensor system or rapid transverse oscillations of strands whose oscillations are excited by the granulation process. Depending on the material, the strands and granules often have diameters of only a few millimeters or even fractions thereof, for example less than 7 mm and often less than 4 mm, so that the objects are very small compared to the size of the detection range of an infrared sensor.

In this respect, contacting temperature sensors have mainly been used to date, which are arranged with a thermocouple in the product stream. However, it is usually problematic that only a small amount of heat is transferred from the product stream or the objects flowing past to thermal sensor. When the object comes into contact with thermal sensor, the Hertzian contact surfaces are very small, the contact time is very short and thermal conductivity of the material, which is usually a plastic, is very low. In contrast, the surface of thermosensor continuously radiates heat into the environment and at the same time also absorbs ambient heat radiation, and is also in convective exchange with the air. If you look at a conventional pellet dryer with a negative pressure fan, the outflowing pellets move out of the outlet together with heated moist air boundary layers. Dry, cool ambient air is drawn in against this flow and flows into the dryer at the outlet in counterflow to the particle flow. The ratio of the swirling air flows of colder counter-air flow and the heated air carried along with the pellets depends on many parameters and can hardly be adjusted reproducibly. Therefore, the result of the contact temperature measurement is ultimately often only a measurement result that is derived from the air temperatures of the various air flows, the product temperature and the pipe temperature of the outlet pipe.

Furthermore, non-contact temperature measurement has also been attempted, wherein infrared sensors can be used for plastic granules in the region of 20° C. to 150° C., for instance, which evaluate the radiation emission of the granules or strands in a wavelength range of for instance 8 to 14 μm, wherein pyrometers and bolometric infrared cameras can be used here. The fastest sensors currently available have a response inertia in the area of slightly less than 10 ms, which means that although granules or particles flowing through the measuring spot of the infrared sensors generate measurement signals that can be recognized as peaks, the dwell time in the measuring spot is far from sufficient for the pyrometer or individual pixels of the bolometric infrared camera to be controlled to the full particle or granule temperature. The situation is comparable for vibrating strands, which can only be captured in partial coverage by a pyrometer or a pixel due to their small width. The maximum temperatures of the individual peaks are unacceptably and hardly usable significantly colder than the actual object temperature measured by temporary accumulation or agglomeration. As already mentioned, compacting the product stream in this way is not permitted, especially for strands and plastic pellets, due to the risk of agglomeration and is only possible under laboratory conditions or for test purposes, but not in the running process of large-scale plants.

Direct infrared measurement is only possible if a compact slip fill forms in the outlet pipe or in the chute when the product filling level is high, but for many products this is undesirable or even impossible. Similar problems arise with strand temperature measurement where, due to the thinness of the strands, a very high resolution of a very expensive infrared camera is required or several cameras have to be installed on a scanner beam at great expense.

Even with powerful infrared sensors in the form of pyrometers and bolometers with only average resolutions, a high signal noise is obtained, wherein the longer response times prevent the sensors from being fully adjusted to the pellet temperature. The granules fly past the sensor or through its measuring spot too quickly for the sensor to respond sufficiently. Both ultimately stem from Boltzmann's law, according to which the radiant power arriving at the sensor system depends on the area and temperature of the granules and the measuring distance, or more precisely P_{Sensor}=ε×σ×A×T⁴/r², wherein ε indicates the degree of emission of the plastic, σ is the Stefan-Boltzmann constant, A is the area of the granule, T is the temperature of the granule and r is the distance of the sensor system from the granule. The temperature of the pellets in the region of for instance 40° C. to 120° C. is very low for an infrared sensor, and the radiation area of the granules or strands is also very small. In addition, the distance between the sensor system and the pellet size is usually very large. The 1/r² distance dependence therefore leads to very weak measurement signals. The small size of the granules and strands leads to the problem with coarser resolution infrared cameras that pixels only partially receive the radiation from the object. Only continuous full coverage of the pixels results in an asymptotic approximation to the actual granule or strand temperature with simultaneously decreasing signal noise, if the granule or strand is in the vicinity of the sensor system for long enough, which is not the case in large-scale processes with high throughput rates.

The patent document DE 10 2016 115 348 A1 attempts to achieve the non-contact temperature measurement of glass fiber strands by means of a thermal image sensor, wherein the problem of movements of the very thin strand relative to the significantly larger pixels of thermal sensor and only small temperature differences of the strands compared to the background are to be compensated for, integrating the measurement signal of the heat sensor over a longer period of time and comparing the integral formed with a reference value that can be determined from a correspondingly long measurement of the background without passing fibers. A black emitter is used as the background emitter, the reflectance of which should be at least approximately 0 in order to avoid reflections of thermal radiation in thermal image of the sensor system. Integral formation is used to determine an average value, so to speak, which should be more accurate than a maximum value of the measurement signal of the heat sensor at a certain point in time. However, the use of a black emitter permanently located near the strand is hardly manageable in practice in large-scale plants due to the problem of contamination. On the other hand, the necessary reference measurement inevitably results in more or less large inaccuracies if the actual temperature of the measuring background changes compared to the reference measurement due to fluctuations in the process control, which is often the case in large-scale processes.

The patent document WO 2014/090994 A2 attempts to measure the temperature of metal strands that are to be coated with an insulating plastic sheath without contact using a radiation sensor that undertakes a spatially resolved thermal radiation measurement from the interior of a tube through which the metal strand runs, wherein the tube should also be configured as a black cavity radiator, wherein edge losses can be minimized with a sufficiently long tube length so that a measurement under specular inclusion conditions is possible in the center. The paper is based on the finding that at identical temperatures of the metal strand and the cavity radiator, the metal strand is no longer visible against the background formed by the inner wall of the pipe and therefore no significant deviation occurs in the region of the moving metal strand in the spatially resolved heat sensor image. On the one hand, this knowledge is used to deduce the temperature deviation of the metal strand compared to the known pipe temperature from the deviation of the signal of the radiation sensor compared to a reference measurement at a known pipe temperature. On the other hand, the knowledge is used to control the temperature by tempering the cavity radiator, which is configured as a tube and whose temperature is easy to measure, to the required target temperature and then adjusting process parameters that influence the metal strand temperature if the measurement signal from the heat sensor exceeds or falls short of the corresponding target value, which is present at a metal strand temperature that corresponds to the tube temperature. With this approach, you can adjust the temperature of the stranded wire to a set temperature, but you cannot measure the temperature of a stranded wire if it is not at the set temperature. Only a non-calibrated measure of the deviation from the background temperature is determined, i.e. slightly hotter or colder than the background. If the object cross-sections and occupancy densities of the objects to be measured are not known, a quantifiable

Calibration to object temperature not possible. Precise measurement of temperatures that do not correspond to the target temperature is not possible. In particular, it is therefore not possible to monitor whether a temperature window is being maintained.

It is the underlying object of the present invention to create an improved method and an improved apparatus of the type, as at the beginning, which avoids the disadvantages of the prior art and further develops the latter in an advantageous manner. Preferably, not only a deviation from a background temperature per se should be determined, but also quantified in order to be able to output or display the actual object temperature in the sense of an absolute temperature value.

In particular, infrared sensors with limited resolution and limited response time should also enable sufficiently precise non-contact temperature measurement in conveying streams with small, fast-moving objects such as plastic strands of strand pelletizers and plastic pellets in large-scale pelletizing systems, especially in system sections with short overall lengths, such as the outlet of a pellet dryer, in which the objects move quickly without a large degree of filling and can be kept sufficiently fluidized. Known solutions for infrared measurement under specular inclusion can often not be used in large-scale systems due to the long installation length, so that special solutions are required here. The temperature measurement result should be suitable for temperature control, in particular for maintaining a temperature window. In order to keep the control technology simple, it is desirable to obtain a low-noise quasi-continuously measurement signal with a known measurement delay time that is as stable as possible.

According to the invention, the task is solved by a method according to claim 1 and an apparatus according to claim 21, as well as a pelletizing apparatus according to claim 34. Preferred embodiments of the invention are the subject-matter of the dependent claims.

It is therefore proposed to engage with signal fluctuations, so to speak, and to examine the intensity of the measurement signal fluctuations more closely. The cause of the fluctuations is that infrared radiation emission alternates between the objects to be measured and the background. Surprisingly, the fluctuation intensities of the sensor signal with simultaneous changes in the radiation background can be used to determine what the sensor would measure if granule-shaped objects were actually in the measuring spot of the sensor long enough or if strands were so wide that there were no problems with partial coverage of sensor pixels. In this respect, the temperature of the background, against which the stream of conveyed material to be measured flows past, is varied in terms of time and/or location by means of a temperature control apparatus, wherein the intensity of signal fluctuations in the measurement signal from the infrared sensors occurring in the process is evaluated by an evaluation device. In a simplest version, signal fluctuation minima can be searched for, wherein infrared measurement signals in these fluctuation minima directly represent the object temperature. In the infrared contrast minimum, the infrared sensors receive infrared radiation of the same intensity from the objects as from the background due to their spectral sensitivity characteristics, so that the measurement signal directly reflects the object temperature.

This measurement signal is basically suitable for process control and monitoring a temperature window in an industrial plant, although with variation of the background purely in terms of time with this simple method, the measurement result is only updated at certain points in time and smaller jumps can occur because measurement noise makes localizing fluctuation minima uncertain. A simple control technology would have to be designed relatively conservatively and slowly for this. For more dynamic control, a more complex prediction model would have to be trained. In order to control the process dynamically within a temperature window in a simple form, a quasi-continuously measurement signal is desirable.

Further challenges lie in the precise temperature measurement with infrared sensors themselves, as the temperatures to be measured differ only slightly from the infrared sensor housing temperature, meaning that the sensor element also receives thermal radiation from its own electronics and housing. The transmission of conventional infrared optics is also extremely temperature-dependent. Manufacturers of infrared sensors therefore go to great lengths to eliminate such influences from the measurement signal using internal temperature monitoring sensors and compensation methods with correction curves. This compensation does not work perfectly, especially with temperature gradients in the measuring head and degrades with ageing.

In advantageous embodiments, measures are therefore provided to improve the infrared sensor accuracy, for example by sensor head temperature control, methods for reducing the influence of emissivity without the need for complex two-color pyrometry, additional temperature measurement of the background with independent measurement methodology for online temperature compensation of the measurement signal, wherein the online updating of the temperature compensation value is possible in the presence of the stream of conveyed material or also during production breaks, a calibration station with blackbody radiator to which the infrared sensors can be briefly positioned.

Furthermore, various statistical methods are included, which on the one hand robustly quantify the signal fluctuations, but on the other hand also filter out the effects of measurement noise and provide a low-noise temperature variable for regression models with a reference temperature calculated for the measurement background. Regression models make it possible to find minima reliably and with verifiable quality by interpolation or extrapolation, so that a reliable and precise object temperature can be determined quasi-continuously.

Furthermore, various apparatuses are described which are well suited to control the temperature of the background and the enclosure in such a way that the objects to be measured are brought into the varying infrared contrast situations in terms of time and/or location against the measuring background, so that objects can be measured in a limited installation space almost under specular inclusion conditions. If local temperature differences and longitudinal temperature gradients of objects are to be analyzed in the measuring area, locally varying backgrounds can also be varied in time and/or several evaluation portions can be defined, in which object temperatures and exact measuring positions are determined locally for each portion using individual regression models.

The central starting point for the temperature measurement or determination is the analysis of the infrared sensor signal for fluctuations and the change in these fluctuations in relation to the background temperature, wherein the infrared sensors are aligned to the stream of conveyed material in such a way that they also receive infrared radiation from the background, at least briefly or for some regions of the measuring field.

If there is an infrared contrast between the objects to be measured and the background when evaluating the spectral sensitivity characteristics of the infrared sensors, the infrared measurement signal exhibits highly dynamic fluctuations in terms of time in the case of fluidized fast-moving granule-shaped objects because there is a different object density in the measuring spot or spots at each moment. The stream of conveyed material of strand-shaped objects, on the other hand, takes place in the longitudinal direction, wherein the strands can be moved smoothly or with a strong rocker in the transverse position, depending on the position and mechanical guidance. With an infrared contrast of the background to the strands and an infrared sensor in the form of a line scan or area scan camera, local intensity fluctuations in particular occur in the transverse direction to the strands. At one pixel there is more background in the image, at another pixel there is more of the object, which may be smaller than the resolution of the infrared camera, but nevertheless the associated sensor pixels are controlled differently. In the case of oscillations in strands, highly dynamic intensity fluctuations in terms of time of the measurement signal also occur, comparable to strand-shaped or granulate-shaped objects.

If there is no infrared contrast between the objects to be measured and the background under the evaluation of the spectral sensitivity characteristics of the infrared sensors, the time and/or location fluctuation of the measurement signal becomes minimal, because the infrared sensors can stabilize to the object temperature over a longer period of time. The infrared radiation from the background controls the sensor element(s) just as intensely as the infrared radiation emitted by the object to be measured. If the measurement is carried out in an environment that creates specular inclusion conditions with homogeneous infrared radiation from a black emitter at object temperature from all spatial directions, it is no longer a problem if the degree of emission of the object to be measured is not ideally ε=1, but only ε=0.9, for example. In this case, the object emits only 90% of the infrared radiation. However, the missing 10% is completely compensated for by specular reflection from neighboring objects or the equally intensely radiating environment to a total emission of 100%, so that the degree of emission no longer has any influence on the measurement.

Furthermore, sensor response times, pixel partial coverage, object surface densities, movement dynamics of the objects to be measured have practically no influence on the measurement signal in the infrared contrast minimum, which stabilizes to the object temperature.

The two situations described with and without infrared contrast differ only in the degree of infrared contrast, which is measured by the extent to which the infrared radiation emitted by the background differs from the infrared radiation emitted by objects. If the temperature radiation of the background is higher or lower than that of the object, there will be fluctuations in the measurement signal. If the temperatures are identical, the radiations are also identical and the fluctuations are minimal. Since the cause of the fluctuations is the intermittent or area-by-area change of infrared radiation from the object and the background, the intensities of the fluctuations also behave in a good approximation linearly to the temperature difference between the object and the background. The greater the temperature difference, the greater the fluctuations; the smaller the temperature difference, the smaller the fluctuations until they reach their fluctuation minimum when the temperature difference disappears.

For analyzing these same measurement signal fluctuations, it is therefore advantageous to maintain the linearity of the fluctuation intensities to the temperature difference in the method for determining a fluctuation intensity measure. Furthermore, the calculation of a degree of fluctuation can be used to reduce a large raw data set of measurement signal values to a few key figures. In order to be able to determine a low-noise degree of fluctuation of the sensor signal for a background temperature, it is advantageous to use a larger amount of sensor data, which can then be analyzed using statistical methods. If a pyrometer is used as an infrared sensor, which as a 1-pixel infrared camera only ever provides a single measured value, this data is usually recorded over a certain period of time (temporal evaluation zone) and evaluated for fluctuations in terms of time.

With a line scan infrared camera that is aligned to strands or granules against a homogeneously tempered background, a degree of fluctuation can be calculated directly from each exposure from an evaluation zone that contains, for example, the entire line scan. Most data can be obtained with an area infrared camera, especially if the background is tempered as a temperature gradient field. Several different local evaluation zones can be defined here, so that different fluctuation measures can be determined from a single infrared image against different background temperatures. The evaluation can also summarize several exposures taken under comparable conditions. Since each evaluation zone now has an extent in terms of time and/or location, the respective degrees of fluctuation can be determined from a larger amount of measurement signal data and thus with less noise.

Combining data in an evaluation zone is based on the following considerations: A certain amount of measurement signal data is required in order to be able to determine a degree of fluctuation using statistical methods, for example. All measurement signal data is recorded under similar infrared contrast conditions, in particular against a similar background temperature. The many elementary events in the measurement signal, sometimes receiving more and sometimes less radiation from the object, are not relevant in detail for the aim of temperature determination and can be described with a few key figures for an evaluation zone:
Degree of fluctuation of the infrared measurement signal (e.g., signal amplitude, various other options see description below)
Background reference temperature (e.g., background temperature or a reference temperature described below)
Location (in particular position in the direction of the stream of conveyed material in the spatial center of the evaluation zone)
Time (in particular the average value between the start and end of recording)
Key figures from the frequency distribution of the temperature measurement signal, in particular:
   Average value of the temperature measurement signal
   Statistical parameters
   If applicable, further key figures on the maxima of the distribution.

The design of the local boundaries for an evaluation zone can be as complex as required in order to cover only the data points of a narrow background temperature window as accurately as possible. However, if the characteristic values the above are subsequently used as input data for regression models that have no problems with noisy characteristic values, it makes little sense to invest a lot of effort in drawing the boundaries of evaluation zones. For a very inhomogeneous tempered background, a grid of evaluation zones can simply be defined. In extreme cases, an evaluation zone can also be regarded as a single data point. In this case, the degree of fluctuation is the measurement signal value itself, because the regressions can also be calculated for this degenerated form of an evaluation zone. Only for a variation purely in terms of time of the background temperature control in a direct minimum search without regression modeling is it necessary for the evaluation zone to contain several data points. Apart from these rather theoretical extreme examples, it is particularly useful to use evaluation zones to reduce the measurement signal data to a few characteristic values at an early stage.

In the following, the intensity of the fluctuation can be understood as a measure that is substantially linearly correlated with the temperature difference between the object and the background. The signal amplitude or span range of the measurement signal is generally suitable as such a measure. For better robustness against outlier values, a small proportion of the largest and smallest measurement data can be omitted and the interdecile range or a differently trimmed range can be used as a measure. The interquartile range is typically less suitable because information-bearing data points are excluded as outliers. The standard deviation has proven to be a particularly suitable linear degree of fluctuation, as it reacts less sensitively to individual outliers than the signal amplitude, takes all data points into account and is easy to calculate without internal rank sorting.

An evaluation zone is characterized in particular by the background temperature for which measurement signal data is recorded. The limits of an evaluation zone are selected so that there are only negligible differences in background temperatures. It therefore makes sense to determine an average background reference temperature for an evaluation zone. Because in some embodiments no metrologically determined background temperature is available, this reference temperature is hereinafter referred to as the reference temperature, wherein a background temperature may be a reference temperature.

To make it possible to use the reference temperature as a reference variable for regression models, non-linear distortions to the background temperature should be avoided so that simple functions can be used for regression models. The following requirements are therefore preferably placed on the reference temperature:
a) The reference temperature should be substantially linearly related to the background temperature; in particular, higher background temperatures should result in higher reference temperatures, which may, however, differ by a positive scaling factor,
b) For the situation of the infrared contrast minimum that the infrared radiation emitted by objects and the background becomes indistinguishable for the infrared sensors, the reference temperature should assume the value of the true background temperature and thus the object temperature as accurately as possible within the scope of technical possibilities.

Furthermore, it is advantageous if the value for the reference temperature for a time and/or location evaluation zone, which is characterized by maintaining a narrow temperature window for the background temperature, is determined with as little noise and stability as possible.

There are a variety of options for determining the reference temperature in a time and/or location evaluation zone, which differ in particular in the effort required for the sensor system and mathematical modeling. If the evaluation zone covers a certain period of data acquisition, it is always assumed for the determination of the reference temperature that time averaging or comparable filtering is undertaken without this being mentioned below. If necessary, data from neighboring evaluation zones can also be used to reduce noise or model the reference temperature using advanced regression models. The background temperature is the surface temperature of the background to which the infrared sensors are aligned.

The following concepts, for example, can be used as reference temperatures, possibly in combination with each other:
1) a directly contacting measured background temperature, e.g., in the form of a foil temperature sensor glued to the background,
2) an indirectly contactless measured background temperature, e.g., in the form of additional infrared sensors attached to the back,
3) the infrared measurement signal, which has significant fluctuations in terms of time and/or location, but can be filtered via an evaluation zone or several neighboring time and/or location evaluation zones before and after the evaluation zone currently being processed by
   a) the data of the zone or zones are averaged or filtered in an appropriate manner, which averages out the short-term and location fluctuations in particular, but downscales the variation of the reference temperature by a reference factor (1−A_{obj}/Aₜₒₜ), so that A_{obj}/Aₜₒₜ varies less than the background temperature, particularly with a higher relative object area density in the stream of conveyed material,
   b) if statistical or image processing methods are used to select data points of the measurement signal of the zone or zones that are likely to represent particularly low radiation components from object surfaces and many radiation components from the background, a reference temperature value can be determined from this using further statistical methods, the reference scaling factor of which is significantly closer to 1 than with the averaging described under a), which is possible in particular for quietly running strands against the background.
4) an indirect background temperature measurement with contact on the back, e.g., in the form of a resistance thermocouple or a thermocouple. During heating and cooling cycles of the temperature control unit, non-ideal heat conduction in the wall thickness of the background creates a certain temperature gradient, which is why the background temperature lags behind the temperature measured on the outside, resulting in a systematic measurement error. This can be minimized using various methods, which is particularly relevant for measurement backgrounds that vary over time:
   a) Simulation of the heat flow through the background wall and estimation of the reference and background temperature based on a model of the assumed heat flow and an assumed or optimized heat diffusion coefficient in the wall,
   b) Additional measurement of the heat flow of the temperature control apparatus on the back of the background with a heat flow sensor and simulation of the reference and background temperature based on a model of the measured heat flow and an assumed heat diffusion coefficient in the wall or one determined from optimization,
   c) Symmetrization of heating and cooling cycles with comparable rates of temperature change when passing through the situation of minimum infrared contrast, wherein a FIFO data buffer always contains the same number of fluctuation minima from heating cycles as from cooling cycles, wherein the regression model independently compensates for the fact that the reference temperature is sometimes slightly too high and sometimes slightly too low,
5) Furthermore, the redundancy that a reference temperature can be determined both from measurement data from contacting or otherwise non-contacting temperature sensors and non-contacting from the infrared sensors can be used for higher accuracy, better stability, mutual monitoring of the sensor systems, co-calibration and analysis of the density of the stream of conveyed material. In particular, the reference temperature can be determined:
   a) as the weighted arithmetic mean of concepts 3 and 4,
   b) by using measurement data according to concept 3 to optimize parameters of the simulation models 4a or 4b based on heat conduction in such a way that a time and/or location offset is minimized. As a result, reference temperatures determined according to concept 3 only differ by one scaling factor from reference temperatures determined with optimized concepts 4a or 4b. A weighted arithmetic mean of concepts 2 and an optimized concept 4a or 4b can be used as the reference temperature for the regression. This includes the option of using only concept 3 or only one of the optimized concepts 4a or 4b.

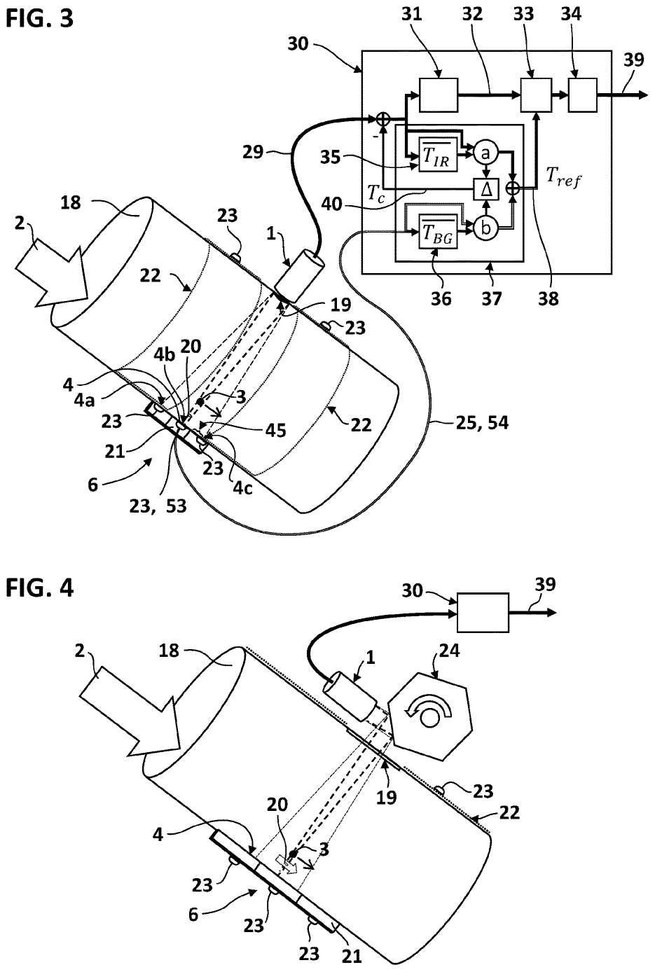

Variant 5b is particularly advantageous, because after the two independent reference temperature methods have been matched to each other, the same reference temperatures should be determined independently of each other in the contrast minimum. In particular, after model adaptation of concept 4a or 4b, the more reliable temperature measurement can be used to determine temperature compensation values T_{c} at regular intervals in order to adjust the measurement signal of the infrared sensors to the more reliably determined reference temperatures, cf. FIG. 3 and description.

Functional models that can be determined by approximation from a point cloud of noisy fluctuation data, e.g., by regression calculation and the method of squared error minimization, as well as models based on machine learning, are particularly well suited for the precise localization of fluctuation minima. For such functional models, minima can be calculated directly using mathematical methods. Advantageously, the background of the measurement objects varies in time and/or location, which is why it is obvious to set up regression models in which, for example, fluctuation amplitudes are plotted against time or location. This is possible, but has the following disadvantages: The required result, the object temperature, cannot be determined directly from the regression, but can be read from the measurement signal at the time/location of the determined minimum in a second step. Because the measurement signal is known to be noisy, it will often be helpful to apply a suitable data filtering method, wherein recorded data of the measurement signal around the found time or location of the fluctuation minimum is used for filtering, e.g., by averaging. In addition, the fluctuation minimum must be included in the recorded data, as simple extrapolation is not possible. Another disadvantage of direct regression against time or location is that the functional relationship of measurement signal fluctuation to time or location can be distorted by non-linearities of the temperature variation in terms of time and/or location, so that more complicated and thus potentially more unstable modeling is helpful for a good functional approximation. A selection can also be made as to which data is suitable for a functional approximation for the minimum search. It is possible to calculate simple direct regression models for the signal fluctuations with respect to time or location, especially if the variation in terms of time of the background is realized via temperature ramps with constant rates of change over time, or the local variation with a homogeneous temperature gradient field.

It is more advantageous to choose a reference temperature, e.g., the background temperature, for the regression modeling of the degree of fluctuation. The degree of fluctuation, e.g., the fluctuation amplitude, reacts largely linearly to the infrared contrast ratio of the temperatures from object to background. A regression model with the reference temperature defined above as the reference variable makes it possible for the position of a minimum fluctuation determined functionally to correspond directly to the determined object temperature. Each data point in the point cloud for the regression calculation now has two scatters: in the ordinate direction the uncertainty of the determination of the degree of fluctuation and in the abscissa direction the uncertainty of the reference temperature determination. The more data available, the more accurately the minimum can be determined. With stable object temperatures, redundantly collected data points are close to each other. With variations in terms of time in the background temperature, several heating and cooling cycles can therefore also be represented in the point cloud, but at the expense of a longer delay time. If the background temperature, starting from a temperature lower than the object temperature, shows increasing temperatures and approaches the object temperature, the fluctuation amplitude drops as the background temperature increases. A fluctuation minimum is reached at the infrared contrast minimum of the same object and background temperatures, and the fluctuation amplitudes increase again as the background temperature continues to rise. This applies to a time curve in a heating cycle as well as to a local curve against the temperature gradient. The degrees of fluctuation plotted against the reference temperature form a point cloud with a minimum. In the left-hand region of colder background temperatures, the fluctuation intensities decrease with higher background temperatures and increase in the right-hand region.

If, for various reasons, the background temperature is not to be changed to such an extent that the fluctuation minimum is reached and passed through, the background temperature at which the fluctuation minimum would occur can nevertheless be determined by extrapolation. The point cloud of the fluctuation intensities at the reference temperatures no longer contains a minimum. Nevertheless, a regression analysis can be undertaken. The background temperature at which the fluctuation intensities extrapolated from the functional relationship would reach zero or a predeterminable value is output as the object temperature.

An area infrared camera with a gradient background should be used for processes in which sudden changes in object temperature need to be measured highly dynamically. This constellation allows an undelayed measurement evaluation for each exposure, because an entire point cloud for a regression model is contained in a single image.

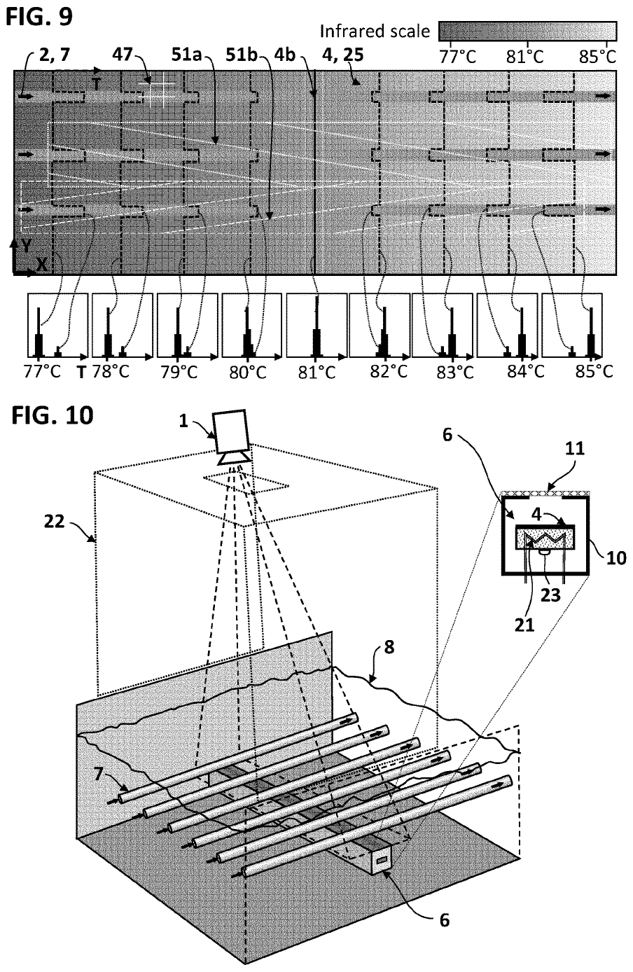

If the change of the object temperature in terms of location in the measuring area is to be determined, which can be particularly relevant along the direction of the stream of conveyed material, several portions can be provided for this purpose, in each of which the object temperature and the exact measuring position are determined. Furthermore, a method is described for FIG. 9 where longitudinal temperature gradients can be determined with temperature variation in terms of time and location.

With many infrared temperature measurement methods, the degree of emission, a material property of the objects to be measured, must be compensated for by multiplicative emissivity correction or expensive two-color infrared measurement technology must be used. Although plastics typically have a high degree of emission of 85-95%, this must be compensated for to ensure accurate measurement. It takes a lot of laboratory work to determine the degree of emission of each recipe and transfer it to the system. An ideal black emitter has a degree of emission of 100% and reflection of 0%. The radiator temperature can be calculated directly from the infrared radiation emission using Boltzmann's law. A plastic object with a degree of emission of 90%, for example, reflects 10% of the radiation on the surface as gloss. The strand-shaped or granulate-shaped objects in the stream of conveyed material are typically convex, so that the infrared sensors receive reflected heat radiation from very different directions on the various partial surfaces of the objects to be measured. At the edges of the objects there is sometimes a specular angle constellation that reflects the radiation emitted by neighboring objects of almost the same temperature. This self-illumination, which has the effect of increasing the degree of emission, can possibly still be compensated for in the case of regularly arranged strands, but the self-illumination situation is uncontrollable in the case of chaotically fluidized granule conveying flows.

As is known from apparatus for measurement under specular inclusion, the influence of the degree of emission can be almost eliminated. For this purpose, the direct surroundings of the measuring spot are brought to such a temperature with an enclosure temperature control system that the infrared radiation almost corresponds to that of a black body radiator at object temperature. Ideally, there is a balanced exchange of radiation between the enclosure temperature control and the objects so that all surfaces emit as much energy as they receive. For wear-resistant surfaces that are exposed to product abrasion dust, enclosure temperature control cannot be realized as a black emitter. Edge effects due to limited installation space and the proportion of infrared radiation reflected by the enclosure temperature control should be taken into account. Ideally, the inner surface of the measuring background and the enclosure temperature control should be homogeneously diffusely scattering, not polarizing and have a degree of emission >85%, but preferably at least >70%. If necessary, these properties can be realized with special coatings. Advantageously, the measuring background to be temperature-controlled and/or the surrounding surfaces of the guide body to be temperature-controlled or the enclosure for guiding the stream of conveyed material can be provided with a suitable coating, preferably made of plastic or a plastic-like material having the high degrees of emission. Advantageously, a lacquer coating and/or a non-stick coating of the conductive body surfaces can be provided, for example made of fluoropolymers and/or silicones.

The measuring background already irradiates the inside of the enclosure temperature control with almost the correct infrared radiation, which keeps the error influence of an illumination of the enclosure temperature control that deviates from the object temperature low. Radiation edge losses in the inlet and outlet zones of the enclosure temperature control are more problematic, because in most systems there is only a limited installation length available for the enclosure temperature control. Radiation losses also occur if the enclosure temperature control cannot seamlessly adjoin the temperature-controlled background, as is the case with a water bath with a background heating bar across the strands. All radiation losses together result in the enclosure temperature control being illuminated from the inside with slightly less radiation intensity than would be the case with an ideal radiation field for measurement under gloss exclusion. To compensate for the non-ideal degree of emission inside the enclosure temperature control and the radiation losses in edge zones, the enclosure temperature control is regulated to a temperature slightly above the determined object temperature.

In order to reduce edge effects and increase the effective degree of emission of the surrounding surfaces of the conductive body or the measuring background or bring it even closer to 1 and save energy, the measuring background and/or the conductive body as well as the enclosure temperature control can have thermal insulation. Alternatively, or additionally, the temperature control device can have large heating and/or cooling elements on the background or guide body surfaces to be temperature-controlled in order to be able to control the temperature of the surfaces efficiently and also quickly in order to reach a required target temperature in fast cycles. In particular, the planar heating and/or cooling elements on the surfaces to be temperature-controlled of the measuring background or the guide body for the stream of conveyed material in the region of the measuring portion can manage the time and/or location temperature gradient or the required variation of the background temperature in terms of time and/or location, during which the fluctuation of the measurement signal is then analyzed in the manner described.

Apparatus for measuring moving objects in front of a temperature-controlled measuring background must typically be adapted to the conditions of the production plant. The measuring background can be formed, for example, by a tubular or channel-shaped guide body in which or through which the stream of conveyed material is guided, but can also be realized in sliding surfaces, side surfaces, cover surfaces, freely suspended or surrounded or immersed by water.

An apparatus for varying the background temperature over time means, for example, that the background temperature in the measuring area of the infrared sensors can be varied in heating and cooling cycles, in particular by the object temperature, by means of a temperature control apparatus. A pyrometer is the preferred infrared sensors for this purpose.

If an infrared line scan or area scan camera is used as the infrared sensors, a more extensive measuring area can be analyzed against the background. This background can be varied in temperature purely over time and can be homogeneously tempered.

However, for faster measurement results, especially with an infrared area scan camera, it is advantageous if the background has different temperatures, for which apparatus for locally varying the background temperature is suitable. A temperature change in terms of location means, for example, that the background is brought to different temperatures by means of the temperature control apparatus along the distance covered by the stream of conveyed material or that a temperature gradient is set up along the conveyed material path, for example in such a way that the guide device in the background, through which the stream of conveyed material is conveyed, is warmer upstream than downstream or, conversely, an upstream guide device portion is colder than a downstream portion. If both implementation options are arranged directly one behind the other, two evaluation portions can be realized, from whose two temperature measurements the temperature change of the stream of conveyed material can be determined, which can allow conclusions to be drawn about cooling measures, core temperatures of the objects or exothermic reactions. However, in order to be able to capture the fluctuation of the sensor system signal at different portions of the measuring portion, the infrared sensors can also have several sensor elements distributed in the direction of the stream of conveyed material or along the measuring portion or in the direction of the temperature gradient.

The temperature gradients in the background can also be at any other angle in relation to the stream of conveyed material, e.g., at right angles to it. Inhomogeneous or circular or periodic temperature fields with temperature gradients in different directions are also possible.

The creation of temperature gradients along the direction of the flow can be achieved by means of heating and/or cooling elements of the temperature control apparatus, which can be distributed along the background. In view of thermal conduction taking place in the background material, it may also be sufficient to heat or cool only a short guide device section in order to provide two opposing temperature gradient fields for two evaluation portions along the direction of flow in the measuring section of interest.

The temperature control apparatus can advantageously comprise one or more temperature sensors, by means of which the temperature of the measuring background or the conductive body or tubular body can be measured, wherein the temperature sensors can operate in a contacting manner. Background temperatures between the temperature sensors can be determined by interpolating two neighboring sensor readings at appropriate distances. Alternatively or additionally, non-contact sensors can also be provided for determining or calibrating the background temperature fields. Depending on the measured background temperatures, the temperature control apparatus can be controlled in such a way that a required location and/or time temperature gradient is produced, which in a middle portion can include a temperature approximately identical to the object temperature to be measured.

The measuring background can also be realized by means of an infrared radiator that shines through a window material that is sufficiently transparent for infrared radiation. In the event of transmission losses, the infrared radiation can be operated at a higher temperature. In the following, the background temperature for such an emitter is defined as the sensor system-weighted infrared radiation emission, which is evaluated identically to a normally emitting background with an almost ideal degree of emission, which is tempered to this background temperature. To ensure that the infrared radiation can be viewed as an emitting background for different temperatures, the emitter can be calibrated with a suitable characteristic curve.

An apparatus for the targeted variation of the background temperature in terms of time and location has, for example, a temperature gradient field, wherein the temperature control apparatus varies the average temperature of the entire temperature field in heating and cooling cycles. Such an apparatus enables the measurement of longitudinal temperature gradients in objects in particular.

The control of the temperature control apparatus and in particular the highest and lowest temperature of the variation in terms of time and/or location should be carried out in automatic coordination with the evaluation device. Typically, a certain range around the object temperature is defined for the variation, which should track the determined object temperature as symmetrically as possible. By means of the temperature control apparatus, the average target temperature of the measuring background can advantageously be readjusted or readjusted in such a way that the objects of the stream of conveyed material flowing past stand out brightly in front of the colder background areas and generate a clearer fluctuation signal, the fluctuation of the sensor signal is minimized in the middle background areas in terms of temperature and the objects settle in front of the hot background areas with a darker signal and thus stronger fluctuations in the infrared signal occur again.

In a further development of the invention, a tube can be used as the measuring background and guide body, which can be rotatably mounted about its longitudinal axis and can be rotated about the longitudinal axis manually or by a rotary drive in order to enable contrast measurement to the background even with denser streams of conveyed material, for which the tube can be brought into a laterally rotated position. The aperture for the infrared sensors can also be offset laterally from the center axis, making it possible to align the measuring spot with the nearby pipe flank. If the infrared sensors have a front mounting flange with an inclined angle to the optical axis, the optical axis can be moved on a conical surface simply by turning the sensor head flange. This makes it possible to align the measuring spot to different zones of the stream of conveyed material, so that a relative object area density in the region of 15-80%, better 25-70%, can be reached for the measuring area.

In an advantageous further development of the invention, the infrared sensors measuring head can be kept at a virtually constant temperature using a temperature control apparatus. Despite fluctuating ambient conditions, the sensor system can be operated within a narrow predetermined temperature window. At high and fluctuating ambient temperatures, higher measuring accuracy, better long-term stability and a longer service life are made possible. Advantageously, such a temperature control apparatus for the infrared sensors can, for example, have one or more temperature control elements on the sensor head of the infrared sensors. For example, a liquid temperature control unit, e.g., in the form of a water sleeve, can be provided on the sensor head in order to cool or heat the sensor head and thereby keep it within the required temperature window.

To calibrate the infrared sensors, it can be provided that the sensor head can ideally be repositioned without interrupting the power supply and temperature control from the measuring position at operating temperature to a nearby calibration station with a largely ideal black emitter reference, which is very precisely and homogeneously controlled to a relevant operating point temperature at the measuring spot position and optionally also the infrared scattered light field is modeled on that of the measuring situation, wherein the infrared sensors are calibrated to the operating point temperature in the repositioned calibration position.

If there are no objects to be measured in the measuring field after the infrared sensors have been repositioned, a transfer calibration to the temperature-controlled measuring background can be carried out directly after the absolute operating point calibration, wherein the background is ideally regulated to the same working temperature of the black emitter reference in a stable manner, wherein a second parallel measurement is then undertaken with the infrared sensors repositioned at the measuring point, in which the infrared radiation of the background is measured simultaneously and the background temperature is captured with contacting temperature sensors, so that the degree of emission of the temperature-controlled background environment can be determined from the results of the second parallel measurement and stored as a calibration parameter for this operating point without a stream of conveyed material.

To improve the accuracy of the temperature determination, the background and the environment can be tempered to an operating point temperature suitable for the next production in phases when there are no objects to be measured, and an update of the temperature compensation in the aforementioned evaluation module can be undertaken with the calibration parameter for an operating point without a stream of conveyed material, so that objects can be measured directly with high absolute accuracy at the start of production without the need for manual absolute calibration using the calibration station and the black emitter reference.

The invention is explained in more detail below by means of preferred embodiments and corresponding drawings. The drawings show:

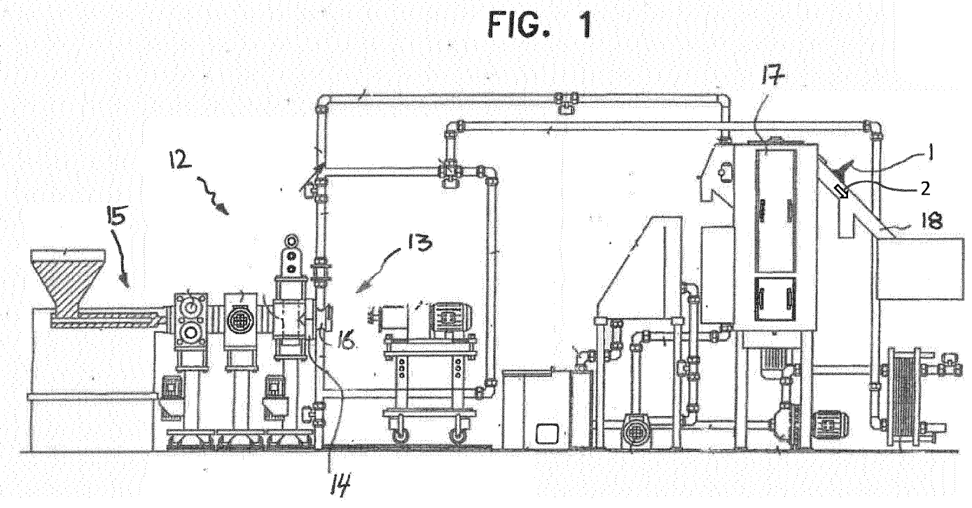

FIG. 1 a schematic side view of an underwater pelletizing plant with an underwater pelletizer, a downstream centrifugal dryer, at the outlet of which an apparatus for non-contact temperature measurement of the emerging pellet stream is provided;

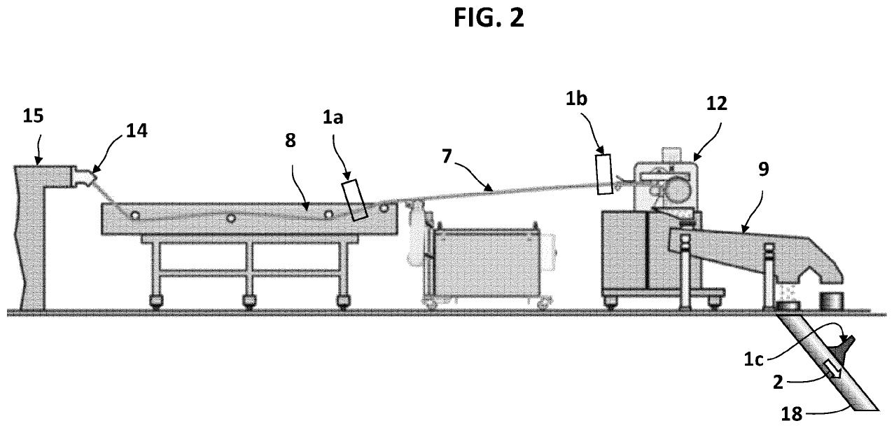

FIG. 2 a schematic side view of a dry-cut strand pelletizing installation with a water bath, with two possible positions of an apparatus for non-contact temperature measurement on strands and an apparatus for non-contact temperature measurement at the outlet of the classifying screen;

FIG. 3 a perspective side view of an outlet and the non-contact temperature measuring device provided there from a previous FIG., with the infrared sensors looking into the outlet pipe through a cut-out on the lateral surface, including the basic scheme of the measurement signal data processing, which applies to all subsequent FIGS.;

FIG. 4 a perspective side view of the outlet similar to FIG. 3, wherein the beam path of the infrared sensors is folded via a movable deflecting mirror, so that a scanning movement in the outlet carried along with the stream of conveyed material is made possible;

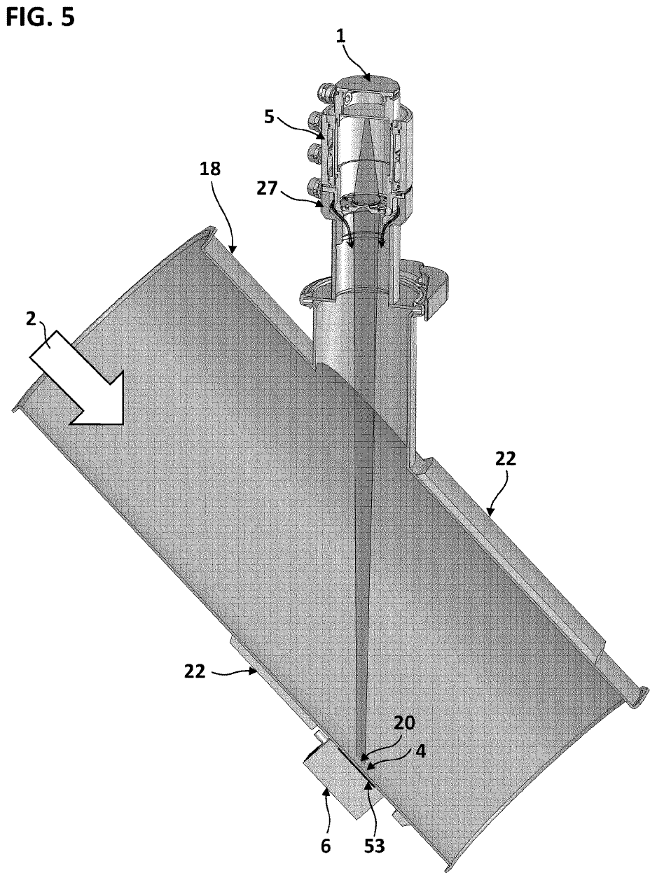

FIG. 5 a sectional view of the outlet with the infrared sensors attached to it and the mounted apparatus for controlling the temperature of the measuring spot background and the tubular enclosure;

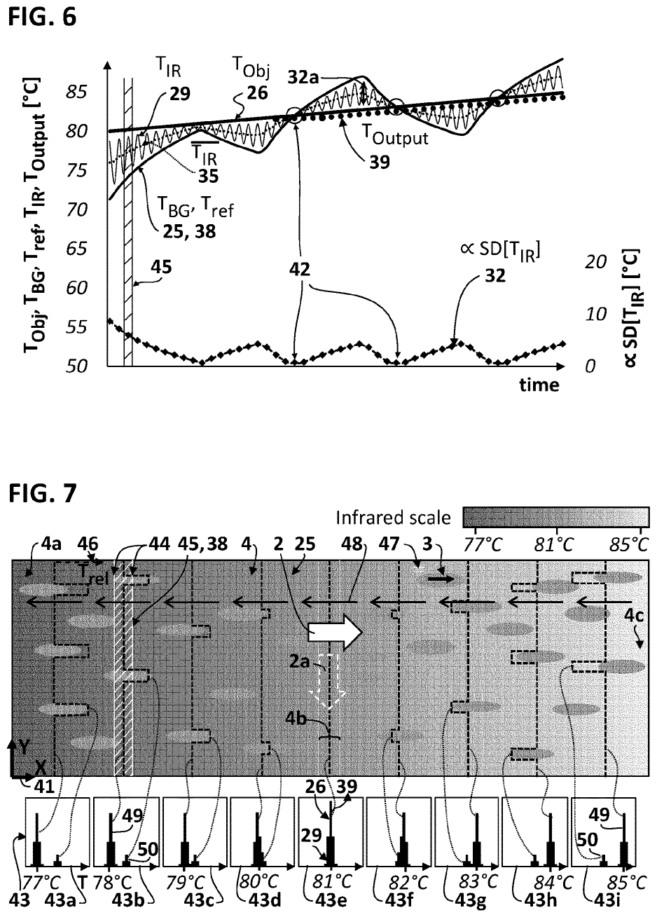

FIG. 6 the time curves of the measurement signal from the infrared sensors with a circular measuring spot (pyrometer) shown in FIGS. 3 to 5, the specifically time-varying measurement background temperature, as well as the fluctuation intensities and the object temperatures determined;

FIG. 7 a representation of moving objects in front of a temperature gradient background measured by infrared sensors with area sensor (infrared camera) from FIGS. 3 to 5 with temperature frequency distributions in evaluation zones;

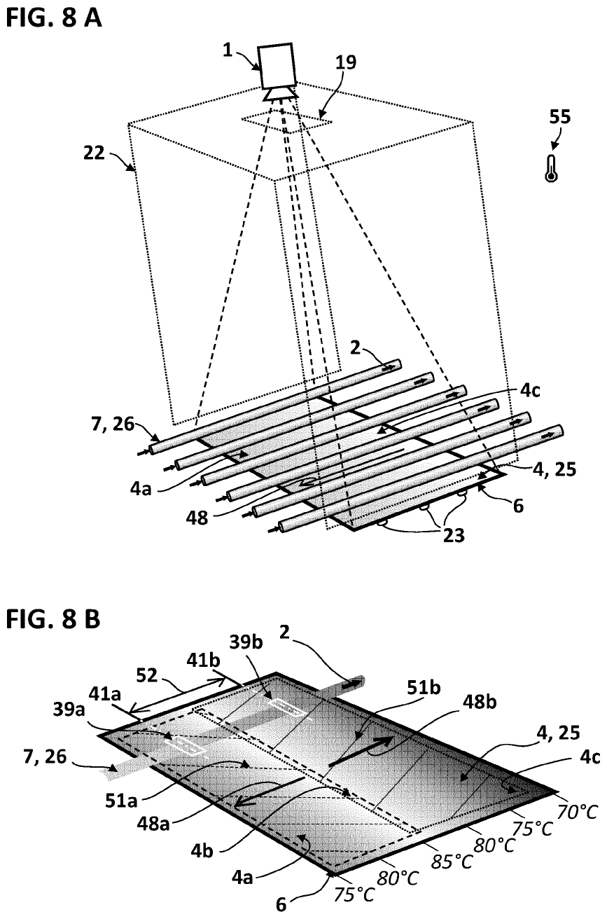

FIG. 8 in FIG. 8A a perspective view of an infrared sensors with area sensor (infrared camera) for measuring the temperature of strands, a background with e.g., a temperature gradient field is located under the strands and the measuring area is optionally surrounded by an enclosure temperature control to minimize the emissivity effect, wherein FIG. 8B shows a more complex design of a background with two temperature gradient fields, which is used to simultaneously determine the object temperature in two portions along the direction of stream of the conveyed material;

FIG. 9 a representation of the locally varying degree of fluctuation of the measurement signal from the infrared sensors of FIG. 8 when using an infrared camera, the background having a temperature gradient field;

FIG. 10 a perspective view of an infrared sensors on strands, wherein a line infrared camera or an area infrared camera is used as the sensor, an infrared radiating background is located under the strands, which can also be immersed in a water bath, and the measuring area is optionally surrounded by an enclosure temperature control to minimize the emissivity effect.

As shown in the figures, non-contact temperature measurement can be used at various positions in large-scale plants for the production of granules. The sensor system is suitable for strand pelletizing systems in dry or wet cut as well as for underwater pelletizing systems. The sensor system can also be used in these and other systems at various measuring positions other than those shown as examples.

FIG. 1 shows a typical extrusion line with underwater pelletizing device 12. A melt feeder 15 presses a polymer melt through a die plate 14 into the cutting chamber 16 of an underwater pellet dryer 13, where the exiting strand material is cut into granules in the water by a rotating knife and conveyed by pipeline to the pellet dryer 17. This is where the granule-water mixture is separated. The separated granules are dried and then emerge from the outlet 18, from where the granules are typically fed to a further processing station such as a classifying screen, a vibrating feeder or a thermal container, for example to carry out a crystallization or self-crystallization process of the granules.

The temperature of the pellets exiting the pellet dryer 17 at the outlet 18 should be within a process temperature window. If the granules are too cold, the residual heat may not be sufficient to allow the residual moisture on the surface to evaporate. If granules are too hot, agglomerates may form due to welding. The process temperature window is particularly narrow for polymers that are intended to retain a high residual heat so that enough energy remains to initiate a directly following crystallization. For some polymers, temperature deviations of only a few degrees Celsius are permitted, otherwise rejects are produced. In particular, the non-contact temperature measurement can take place in the outlet 18, through which the dried granules emerge in the form of a stream of conveyed material 2. The granule-shaped objects of the stream of conveyed material 2 do not usually emerge in the form of a sluggishly flowing, compact stream of granules, but fly more or less spaced apart and fluidized through the tubular outlet 18. Warm moist air from the pellet dryer 17 can also be entrained in the boundary layer of the granules. In typical operation, a slight negative pressure is generated in the pellet dryer 17 by a suction fan, so that a drying counter-air flow is sucked into the outlet 18 in the opposite direction to the outgoing stream of conveyed material 2. Overall, complex flow conditions with different air flows of different temperatures can therefore prevail in the outlet 18, which are guided through the outlet 18 in addition to the granule-shaped objects of the stream of conveyed material 2.

The infrared sensors 1 can be assigned to the outlet 18 and look into its interior in order to be able to measure the temperature of the objects 3 flowing past.

The inner wall of the outlet 18 forms the background 4 for the temperature measurement, wherein in the case of a preferably circular cylindrical outlet tube, the inner surface of the tube forms the background 4 for the temperature measurement, cf. FIGS. 3-5.

FIG. 2 shows a classic dry-cut pelletizing apparatus in which a melt feeder 15 presses polymer or other materials through a die plate 14 and parallel strands 7 are formed, which are first passed through a water bath 8 and then cut in a pelletizing apparatus 12. Various further processing stations can be arranged downstream, as explained in FIG. 1. Shown here is a classifying screen 9, from which the stream of conveyed material 2 is directed into an outlet pipe 18. For the temperature measurement on strands 7, two positions for the sensor system are shown as examples: a first infrared sensors 1a is arranged above the water bath 8, cf. FIG. 10, wherein a temperature-controlled background infrared radiator is located in the water bath 8 and the strands 7 still in the water are measured by the infrared sensors 1a. Another infrared sensors 1b, preferably with a temperature gradient background, is arranged in the inlet zone to the pelletizing apparatus, cf. FIG. 8A. From an infrared image of the strands 7 in front of a temperature gradient background, the individual temperatures of all strands 7 can be measured precisely and highly dynamically, even if the strands should oscillate there dynamically. A two-portion temperature gradient background, cf. FIG. 8B, can be used to check whether short-term strand temperature changes occur between two evaluation portions along the direction of the conveyed material flow, e.g., due to the heating of the outer skin of the strand by a hot strand. An infrared sensors 1c in the outlet 3 can be used to measure the temperature of the granules after cutting in a fluidized stream of conveyed material 2, see also FIGS. 1 and 3 to 5.

Various other strand pelletizing installations with automatic strand infeed in wet and dry cutting, which are not all shown individually here, can also be equipped with non-contact temperature measurement technology on strands and cut granules, wherein the sensor system on strands can be used in particular in chute regions, where small zones of the chute can be designed as heated backgrounds or background infrared radiators can be used in water-cooled regions.

As FIG. 3 shows, the infrared sensors 1 can look with its optics through an aperture 19 into the interior of the outlet 18, so that the infrared sensors 1 have at least one measuring spot 20 inside the outlet 18, through which the stream of conveyed material 2 moves. If an infrared camera is used as the infrared sensors 1, a larger measuring area is captured, wherein a separate measuring spot 20 is measured from each pixel or group of pixels. As an example, a moving granule-shaped object 3 is shown in the measuring spot 20 of the infrared sensors 1.

The inner jacket surface of the outlet 18 and thus the background 4 is advantageously provided with a high degree of emission, which can be reached by a corresponding design of the outlet wall and/or a suitable coating of the wall surface forming the measuring background 4 and the region of an enclosure temperature control 22. For example, the inner wall of outlet 18 can be coated with a plastic-like coating, a lacquer or, in particular, a non-stick coating made of fluoropolymers or silicones, which have a high degree of emission.

The outlet 18 and thus the background 4 can be temperature-controlled by a temperature control apparatus 6 at least in the region of the measuring spot or spots 20, wherein the temperature control apparatus 6 can comprise at least one heating and/or cooling element 21 which is attached to the wall of the outlet 18.

Preferably, an enclosure temperature control system 22 can be provided in the vicinity of the temperature control apparatus 6, for example in the form of a heating sleeve, which encloses the outlet 18 at least in sections and may have several zones in order to generate different temperatures in different portions of the outlet 18.

In particular, the temperature control apparatus 6 may be configured to vary the temperature of the background 4 in terms of location and/or time during the measurement of the infrared sensors 1. The temperature of the entire outlet 18 can also be uniformly increased and decreased via the enclosure temperature control 22. If the temperature of the background 4 is varied in terms of location, the temperature control apparatus 6 can heat and/or cool different background zones 4a-c of the outlet 18 in different ways, for example to set different temperature fields along the path of the stream of conveyed material 2. For this purpose, temperature fields can take on any shape, have any number of zones, temperature minima and maxima and temperature jumps, as long as different background temperatures occur simultaneously depending on the location. The temperature fields can also change in terms of time. An independent measurement of the background temperature 25 can be made using contact or non-contact temperature measurement technology, which can optionally be supported with temperature simulation models into which measurement data from different locations of the background 4 can be incorporated, wherein a measurement of the background temperature 25 is not required, but can nevertheless be provided. The stream of conveyed material 2 usually does not completely cover the background 4, so that a reference temperature 38 can be determined from the measurement signal 29 alone, which is at least partially influenced by the background temperature 25. For an inhomogeneously tempered background 4, for example, reference temperatures can be determined individually for all zones starting from any grid of evaluation zones 45. Thereafter, there is the option of combining evaluation zones 45 of similar reference temperature 38 into larger evaluation zones 45 and subsequently using these larger evaluation zones 45 and determining degrees of fluctuation 32 and reference temperatures 38 for them.

The temperature of the background 4 can be controlled by the temperature control apparatus 6, wherein one or more temperature sensors 23 can measure the temperature of the outlet 18, depending on which the temperature control apparatus 6 can then be controlled.

The data processing of the measurement signal 29 takes place in an evaluation device 30. If there is more than one evaluation portion 51, cf. FIG. 8B or FIG. 9, the respective subsets of measurement data are assigned for each portion 51 in a first pre-processing step.

In a second pre-processing step, the measurement signal 29 is optionally corrected with a temperature compensation value T_{c} 40.

A single complete data processing operation is then performed for each portion 51 and a determined object temperature 39 is output in each case.

The individual data processing procedure is as follows: The fluctuation intensities of the measurement signal 29 are evaluated by a fluctuation evaluation module 31 over a certain amount of signal data, which comprises a time and/or location evaluation zone 45 of similar background temperature, and output, for example, in the form of the fluctuation amplitude as a degree of fluctuation 32, which is basically proportional to the measured infrared contrast between the object and the background. Alternative methods of determining the degree of fluctuation 32 are shown in the description. Further sets of signal data from other evaluation zones 45 are evaluated in the same way, so that different degrees of fluctuation 32 are available for different background temperatures 25. If the background temperature 25 varies in terms of time, a certain amount of time is required to capture different evaluation zones 45; if the background temperature 25 varies in terms of location, different evaluation zones 45 can be captured and evaluated simultaneously. For each time and/or location evaluation zone 45, a reference temperature 38 is determined in a reference temperature determination module 37, which can be used as a reference variable for the regression model 33. The reference temperature 38 can be calculated, for example, from the averaged background temperature 36 or the averaged infrared measurement signal 35, a weighted arithmetic mean thereof and various other methods. In particular, the description presents methods that use image processing, statistics and heat diffusion modeling to internally determine two reference temperatures using two independent calculation paths: Modeling a—based on infrared measurement data 29 and Modeling b—based on background temperature 25 and optionally heat flux measurements 54 of a heat flux sensor 53. From the difference Δ between Modeling a and b, a temperature difference T_{c} 40 can be determined in regular cycles for the fluctuation minimum, for the described temperature compensation of the measurement signal 29 in a pre-processing step in the evaluation device 30.

In a regression module 33, the functional relationship of the degree of fluctuation 32 to the reference temperature 38 is determined and the determined object temperature 39 is determined by a minimum search 34, or by extrapolation of the intersection points of a regression function with the zero axis or a predetermined value.

If the background 4 is divided into several evaluation portions 51, cf. FIG. 8B and FIG. 9, which can be as small as pixel lines, object temperatures 39 can be determined for each portion using section-specific regression models 33 for the respective section area. If, for example, the background temperature field has complex temperature gradients 48 (cf. e.g., FIG. 8B), so that infrared contrast minima of the objects 3 to the background 4 occur in two or more evaluation portions along the course of the stream of conveyed material, a certain location resolution in the direction of the stream of conveyed material 2 can be reached by determining local object temperatures 39 in locally different portions 51. The more portions 51 with suitably tempered background 4 are provided, the finer the spatial resolution.

In an evaluation portion, for example, an upstream portion 4a of outlet 18 may be colder than the stream of conveyed material 2. A central portion 4b of the outlet 18 can be tempered at least approximately to the temperature of the stream of conveyed material 2. A downstream portion 4c of the outlet 18 can be brought to a temperature hotter than the stream of conveyed material 2, cf. FIG. 7.

FIG. 4 shows a periodically deflected measuring spot compared to a fixed measuring spot as shown in FIG. 3. The beam path of the infrared sensors 1 is folded with dynamically changing angles, e.g., via a rotating prismatic mirror 24. The measuring spot 20 or the measuring area of an infrared camera is moved by deflection in such a way that it follows the direction of flow of the stream of conveyed material 2 at as similar a speed as possible to the moving objects 3. For this purpose, the aperture 19 is machined into the outlet 18 in the direction of movement in the form of an elongated slit. The temperature control apparatus 6 or its heating and/or cooling elements 21 are also designed to be correspondingly longer, as is the enclosure temperature control 22, in order to be able to control the temperature of a longer outlet section or background section.

With a continuous rotational speed of the prism mirror 24, the angular relationship or the changing distance does not result in an exactly constant scanning speed of the measuring spot 20. However, the rotational speed of the prismatic mirror 24 can be controlled depending on the angle, so that the measuring spot 20 is actually moved along against the background 4 at a constant speed. If the scanning speed of the measuring spot 20 corresponds well with the speed of the stream of conveyed material 2, the time during which the infrared sensors are stably aligned with a moving object 3 increases considerably. This makes it possible to measure the temperature of individual moving objects 3 and determine the temperature distribution of the objects in the stream of conveyed material 2. The temperature control apparatus 6 is advantageously constructed from several separately controlled heating/cooling elements 21 so that a temperature gradient field of the background 4 is formed in particular transversely or along the scanning direction. The background temperature at the location where the contrast of the moving object 3 disappears indicates the temperature of this individual object.

As FIG. 5 shows, the infrared sensors 1 can also look into the interior of the outlet 18 at an angle. Such an oblique arrangement at an angle of, for example, 30° to 80° or 35° to 55° to the longitudinal axis of the outlet can be provided when the measuring spot 20 is fixed, but in principle also when using the aforementioned prismatic mirror 24. The enclosure temperature control 22 is designed here in the form of a heating sleeve with a recess for the temperature control apparatus 6. A water temperature control sleeve 5 is arranged around the measuring head of the infrared sensors 1, which enables temperature-stabilized operation of the sensitive sensor system. Advantageously, the infrared sensors 1 can be operated with active temperature control in a narrow temperature window, so that the sensor system 1 can measure precisely over the long term with maximum accuracy despite fluctuating ambient conditions, wherein this temperature control can preferably be realized with a water temperature control sleeve 5 around the sensor head.

To protect the lens of the infrared sensors 1 from dust or soiling, finely filtered instrument air flows downwards from the purge air nozzle 27 towards the stream of conveyed material 2. A combined temperature and heat flow sensor 53 can optionally be used in the heat transfer contact from the temperature control apparatus 6 to the outlet 18. This allows the heat flow transferred to the outlet 18 during heating and cooling operation of the temperature control apparatus 6 to be measured and the temperature of the background 4 to be determined even more precisely from thermal conductivity coefficient known via the wall material, as explained in the description.

As shown in FIG. 6, the background temperature 25 of the background 4 is varied in terms of time, as is possible, for example, with a temperature control apparatus 6 according to one of FIGS. 3 to 5 or 10. The infrared measurement signal 29, which is illustrated here in simplified form as a thin wavy line, fluctuates very dynamically because sometimes more infrared radiation is received from objects 3 or sometimes more from the background 4 in the measuring spot 20 of the infrared sensors 1. The fluctuation amplitude 32a of the measurement signal 29 is higher the more the background temperature 25 deviates from the object temperature 26. The measurement signal 29 practically always fluctuates only between object temperature 26 and background temperature 25, which means that this fluctuation almost disappears if object temperature 26 and background temperature 25 are the same, i.e. in the spectral evaluation of the infrared sensors 1, the radiation from the objects becomes indistinguishable from the radiation from the background 4. In this situation of a contrast minimum 42, the value for the determined object temperature 39 can be taken directly from the measurement signal 29 or from a measurement signal 35 averaged using a low-pass filter, for example, or from the background temperature 25.

In order to regularly pass through such contrast minima 42, the background temperature 25 can in particular be cyclically increased and decreased again, wherein the average value between the increases and decreases of the temperature can also be varied at the same time, in particular in order to approximately approach the object temperature 26 as the average background temperature 25. As FIG. 6 illustrates, the temperature cycles are initially too low, which means that the boost cycle is still below the object temperature 26. However, if the mean temperature is also adjusted, the background temperature 25 and its variation can be set in such a way that the background temperature 25 oscillates around the object temperature 26, cf. the right half of FIG. 6.

In particular, the degree of temperature variation of the background 4 is selected here such that as the background temperature 25 is varied, these degrees of fluctuation 32 vary such that the degree of fluctuation 32 periodically passes through minima as the infrared contrast between the object and the background disappears. The degree of fluctuation 32 is plotted on the right ordinate axis in FIG. 6, wherein “αSD[T_{IR}]” is proportional to the standard deviation of the infrared measurement signal. If the background temperature 25 is increased above the object temperature 26, the degrees of fluctuation 32 increase. If the increase in the background temperature 25 is reduced again, the degree of fluctuation 32 decreases again until it reaches a fluctuation minimum once more. If the background temperature 25 is then lowered below the object temperature 26, the degree of fluctuation 32 increases again, which in turn is reversed if the background temperature 25 is increased again from the lowered state, so that an amplitude minimum occurs again when the background temperature 25 reaches for instance the object temperature 26 again.

The measurement signal 29 from the infrared sensors 1 is evaluated by an evaluation device 30, as described for FIG. 3. In evaluation zones limited in terms of time 45, the time of which is so short that the background temperature 25 can still be assumed to be largely unchanged, a degree of fluctuation 32 is calculated for each evaluation zone 45. The acquisition period in which the measurement signal 29 is recorded in order to be able to determine a degree of fluctuation 32 for the evaluation zone 45 can be defined within wide limits, up to the point where it consists of only a single data point and the actual fluctuation analysis is carried out in a subsequent regression calculation. In many cases, however, it is advantageous to reduce the large amount of measurement signal data 29 to a few characteristic values at an early stage and to summarize data, for example, in the region of tenths of a second to a few seconds. Various calculation options are presented in the description for calculating the degree of fluctuation 32. The individual measured values of the measurement signal 29 are recorded in short cycles in order to determine the degree of fluctuation 32 of the measurement signal 29.

In parallel, the measured values of the background temperature 25 are averaged in the same cycle. In this example, the time-synchronized data for the degree of fluctuation 32 and the associated averaged background temperature 25 are temporarily stored as reference temperature 38, for example in a FIFO data buffer, for regression evaluation.

If measurement data from one or more temperature sensors 23 is available for the background 4 independently of the infrared sensors 1, the contrast minima 42 offer a good opportunity for co-calibrating the measurement signal 29, which can be influenced by many disturbance variables, to the background temperature 25, which can be determined more reliably, e.g., via these same temperature sensors 23. Furthermore, in phases where the object temperatures 26 are obviously constant over a longer period of time, the background temperature 25 can be controlled as close as possible to the object temperature 26 for a certain period of time. In this stationary state of the contrast minimum, there is sufficient time to adjust the temperature sensor signal 23 to the background temperature 25 and the difference between the infrared measurement signal 29 and the background temperature 25 measured by the temperature sensor 23 can be used directly as a temperature compensation value 40, especially if it has been checked after the stationary phase by means of temperature variation of the background temperature that almost identical object temperatures 39 could be determined before and after.

FIG. 7 shows the evaluation of a measurement signal image or a portion as an image section of a multi-section measurement signal image of an infrared sensors 1 in the form of an area infrared camera, as can be used for apparatus according to FIGS. 3 to 5. FIG. 7 shows moving objects 3 of a stream of conveyed material 2 curving in the X direction 41 against a background 4 with a homogeneous temperature gradient field 48 in a temperature-visualizing false color representation. The background 4 is colder than the objects 3 in an upstream portion 4a, has near object temperature 26 in a middle portion 4b, and is warmer than the objects 3 in a downstream portion 4c. The temperature field of the background 4 can also have different and different gradient directions and considerably more complex inhomogeneous temperature fields with different temperature zones and jumps, which create the prerequisite for measuring moving objects 3 at different locations against the background temperature 25. Evaluation zones 45, which comprise a certain background temperature window, can be realized in a homogeneous temperature gradient field in simple form by rectangles which are approximately bounded by isothermal lines 44. For inhomogeneous background temperature fields, more complex geometries or grids, for example, can be used for the boundaries of the evaluation zones 45 in terms of location, see description.

Due to the short dwell time of an object 3 in the measuring spot 20 of a pixel 47 in relation to the response time of the infrared sensors 1, the measurement signal 29 in the excited pixels 47 reacts with a time delay and thus generates an afterglow trace with soft edge transitions, which is visualized here in simplified form as an ellipse 3 with sharp contrasts. With an apparatus as shown in FIG. 4, this afterglow trace can be minimized so that granules that move exactly at the scanning speed of the moving measuring spot are largely imaged with their true object contour and only short afterglow traces are formed towards the front or rear for individual objects 3 that move slightly slower or slightly faster than the scanning speed. This means that the dwell time of the object 3 in front of the controlled pixels 47 is long enough for the measurement signal 29 to reach full level, from which an individual object temperature 39 can be determined for each individually captured object 3 using simple image processing.

To determine the mean object temperature 39, various degrees of fluctuation 32 are determined from an infrared image of a measurement section for different evaluation zones 45, which in the example shown are formed by temperature windows of ±0.15° C. around the respective mean background temperature 25 with isothermal lines 44 as the limit. As an example, nine evaluation zones 45 are evaluated in FIG. 7. For this purpose, the measurement signals 29 of all pixels 47 within a respective evaluation zone 45 are statistically evaluated, wherein the standard deviation is particularly suitable for determining the degree of fluctuation 32. Alternative statistical parameters such as the range or the interdecile distance are discussed in the description. To visualize the statistical scatter of the measurement signals 29 within the rectangular evaluation zones 45, temperature histograms 43 are shown at the bottom of FIG. 7, which refer to the data in the respective evaluation zones 45 in the infrared image above, wherein only the evaluation zone 45 is explicitly drawn with reference to the histogram 43b. A reference temperature 38 is determined for each evaluation zone 45, which can be done, for example, by averaging the background temperatures 25 of this zone or by other methods described.

In the false color image, the local infrared contrast to the center axis of each evaluation zone is shown in a dashed black line of the relative temperature Tᵣₑₗ 46 for a column of pixels, wherein Tᵣₑₗ is calculated as the difference of the measurement signal 29 to the reference temperature 38 of the respective evaluation zone 45. The infrared contrast is visible in the temperature histograms 43 in the distances between the maxima 49 and 50 of the temperature distribution. All histograms 43a-i have the same axis scaling for the temperature, wherein only the reference temperature 38 is labeled in each case. The distances between the maxima 49 and 50 are particularly large in the downstream portion 4c in histogram 43i and in the upstream portion 4a. In the middle portion 4b, the temperature histogram 43e shows only a central maximum, because the objects 3 have an object temperature 26 that is almost identical to the background temperature 25 without infrared contrast. In this middle portion 4b, the pixels 47 of the infrared sensors 1 are almost stable with their associated measuring spots 20 in balanced radiation exchange, so that as an alternative to regression methods, the determined object temperature 39 can also be read directly from the histogram 43e with the smallest standard deviation as the temperature value at the point of the main maximum 49, 81° C. in this example. A disadvantage of this method is that the determined object temperatures 39 can jump from measurement to measurement between different evaluation zones 45 during successive measurements with different positions of the objects 3.

For the evaluation method, the angular orientation of the stream of conveyed material 2 with respect to the background temperature gradient field 48 is not relevant, provided that it can be assumed that the object temperature 26 can be assumed to be approximately constant at all locations in the infrared image or in a portion of the infrared image. In the case of non-negligible cooling of the object temperature 26 during movement across the various regions of the background 4, it may be advantageous to orient the temperature gradient 48 of the background 4 opposite to the direction of the stream of conveyed material 2. This ensures that the variable object temperatures 26 in terms of location clearly intersect with those of the temperature gradient field 48 and do not run parallel in some zones, which can create problems for minimum search 34 in zones of constant degree of fluctuation 32. If it is possible that the moving objects 3 heat up during the measurement due to exothermic processes, such as chemical reactions or crystallization, it may be useful to orient the temperature gradient field 48 in parallel with the stream of conveyed material 2.

A stream of conveyed material 2a that curves transversely to the direction of the temperature gradient field 48 can be used if relevant changes in the object temperature 26 in an unknown direction are expected during the movement across the background 4, and homogeneous object temperatures 26 can be assumed transversely to the stream of conveyed material 2. In almost all cases, it will be sufficient to set a sufficiently steeper temperature gradient in the background 4 relative to the gradient created by changing the object temperature 26 as the objects 3 move across the background 4.

FIG. 7 also implicitly shows a special situation of the background 4, namely that it is very narrow and, for example, only has the width and height of the one white hatched evaluation zone 45 above histogram 43b as its overall dimensions. As explained at the beginning, this narrow background 4 can have any temperature gradient field 48, wherein the width should, however, be assumed to be so narrow that any existing temperature gradient in the X direction is negligible. Two relevant scenarios in particular will be discussed for the curve of the background temperature 25 in the Y direction:
Scenario A: The white shaded image area, which in this special situation comprises the entire background 4 of the infrared sensors 1, or a complete section of the image, has a temperature gradient oriented in the Y direction. This scenario is completely covered by the description just shown, as it is merely a representation of FIG. 7 rotated by 90° with the only difference being that the stream of conveyed material 2a curves vertically and the afterglow traces of the moving objects 3 are formed accordingly in the V direction.

Scenario B: The white shaded image area, which in this special situation comprises the entire background 4 of the infrared sensors 1 or a complete section of the image, is homogeneously tempered in the V direction.

The associated histogram 43b visualizes the statistical distribution of the measurement signals 29, from which a degree of fluctuation 32 that is largely linear to the infrared contrast can be determined using the standard deviation method, for example. Other statistical methods are discussed in the description. The infrared contrast situation currently visualized in the temperature histogram 43b is as follows: The background 4, which in this special situation is limited solely to the white shaded evaluation zone 45, is homogeneously tempered to 78° C. The relative object surface density in the stream of conveyed material 2 is rather low, so that the maximum 49 is dominated by pixels 47, which substantially receive infrared radiation from surfaces of the background 4.

As all pixels 47 are regularly driven to higher measurement signal values 29 close to the object temperature 26 of 81° C. by warmer objects 3, the dominant maximum 49 in the temperature histogram 43b is slightly above 78° C. due to afterglow effects. Similarly, the secondary maximum 50 does not quite reach the object temperature 26 and is slightly lower than 81° C., as the pixels 47 do not receive more intense infrared radiation from the objects 3 for long enough. The fact that this is better achieved with an apparatus as shown in FIG. 4 and that the maxima 49 and 50 can thus reach the exact values of background temperature 25 and object temperature 26 much more closely is explained in detail elsewhere. In summary, the evaluation of the measurement signal data 5 visualized in the temperature histogram 43b of this special situation of a background 4 of the size of the white hatched evaluation zone 45 can be described in such a way that the background temperature 25 is still significantly below the object temperature 26 and subsequently, for further increasing higher background temperatures 25, the at least initially decreasing degrees of fluctuation 32 should be captured in order to determine the object temperature 39 from the data collection of different degrees of fluctuation 32 in terms of time at different background temperatures 25 by regression analysis. This method is identical to the method described in FIG. 6 for varying the background temperature in terms of time and processing degrees of fluctuation 32 in a regression model 33. For the analysis of the fluctuations of the measurement signal 29, it is therefore irrelevant whether these are determined via the variation of a single pixel 47 in terms of time, i.e. the single measuring spot 20 of infrared sensors 1 designed as a pyrometer, or via the fluctuation of the infrared intensity in terms of location, which is captured with a line of infrared sensors 1 via the narrow background strip described as a special situation. As an alternative to an infrared line scan camera, an infrared area scan camera can also be used as infrared sensors 1, wherein only the pixels 47 of the measuring section in the form of a strip-shaped image section (region of interest, ROI) are read out, the measuring spots 20 of which are aligned on the tempered strip-shaped background 4, as can be realized with an apparatus according to FIG. 10.

FIG. 8A shows a version of the infrared sensors 1 which, in the form of an area infrared camera, is aligned in the field of view to one or a plurality of strands 7 which move in the longitudinal direction of the strand as a stream of conveyed material 2. To reduce the influence of the degree of emission of the strands 7 to be measured, enclosure temperature control 22 is recommended. To reduce edge effects, the aperture 19 should not be larger than necessary. If possible, specular from the strand surfaces captured from a camera perspective should come from spatial directions that are covered by the enclosure temperature control 22, although certain edge effects due to infrared radiation at ambient temperature 55 in the inlet and outlet can hardly be prevented. Behind the strands 7 is a measuring background 4, which has a somehow structured temperature field with the help of the temperature control apparatus 6, so that different background temperatures 25 are simultaneously present at different locations in the field of view of the infrared camera 1. Additional temperature information 25 of the background 4 can be determined with temperature sensors 23, which can be contacting or non-contacting, so that the background temperature 25 for each location of the background 4 is at least approximately known from this and the information of the infrared sensors 1. However, it is also sufficient to determine reference temperatures for temperature zones with a similar background temperature 25, as described for the data processing scheme in FIG. 3. In order to be able to measure strand temperatures 26 individually, it is advantageous if the temperature gradient field 48 of the background 4 has temperature gradients oriented substantially in the direction of movement of the strands 7. If, for example, a thin layer of water still adheres to the strands 7, which causes a strong ablation cooling effect, the strand temperatures 26 drop along the direction of the stream of conveyed material 2. For a stable regression model 33 to determine the temperature of the strings, it is therefore advisable to align the temperature gradient field 48 in the background 4 in the opposite direction to the temperature gradient in the strings 7, i.e. warmer than the strings 7 in the downstream portion 4c and colder than the strings 7 in the upstream portion 4a. Oriented the other way around, the temperature gradient field 48 should have sufficiently steeper temperature gradients than the gradient of the strand temperatures 26 in the longitudinal direction of the strand.

To measure the temperature gradient of the strand temperatures 26 in the longitudinal direction of the strand, further portions with other background temperature gradients 48 can also be used in the direction of the stream of conveyed material 2. Regression models 33 assigned to the individual evaluation portions 51 then determine respective local object temperatures 39 for the individual portions.

FIG. 8B shows such a simple subdivision of the background 4 into portions 51, wherein the object temperatures 39a, 39b are determined independently of one another for two slightly overlapping evaluation portions 51a and 51b at different positions 41a, 41b of the stream of conveyed material 2. The temperature control apparatus 6 is used to set a low background temperature 25 in an upstream portion 4a, a background temperature 25 that is higher than the strand temperatures 26 in a middle portion 4b and an even lower background temperature 25 than in portion 4a in a downstream portion 4c. In evaluation portion 51a, the temperature gradient field 48A curves against the direction of the stream of conveyed material 2, in evaluation portion 51b, the background with a more intensive temperature gradient field 48B is carried out with the direction of the stream of conveyed material. This means that separate evaluations can be undertaken for both evaluation portions 51a and 51b. As an example, a strand 7 is shown in a temperature-visualizing false-color representation against the background, wherein the strand temperature 26 decreases along the direction of the stream of conveyed material 2. In evaluation portion 51a, the fluctuation minimum and thus the determined object temperature 39a of approximately 80° C. is reached in an evaluation zone at position 41a. In a separate temperature evaluation of the second evaluation portion 51b, located downstream, a further fluctuation minimum at position 41b is evaluated and the object temperature 39b of approximately 76° C. is determined there. The longitudinal temperature gradient in the strands 7 can now be determined simply as the difference temperature 39a to 39b divided by the distance 52 of the measurement positions 41b and 41a, the exact position values of which are determined from regressions for each of the evaluation portions.

FIG. 9 shows the evaluation method of a measurement signal image of infrared sensors 1 in the form of an area infrared camera, as it can be used for an apparatus according to FIG. 8A. This temperature-visualizing false color image can also represent an evaluation portion, i.e. an image section, so that several evaluations are calculated section by section for an entire measurement signal image, cf. FIG. 8B. The only difference compared to FIG. 7 is that here, instead of moving strand-shaped or granulate-shaped objects 3, continuous strands 7 run against the background 4. The stream of conveyed material 2 takes place substantially in a continuous longitudinal movement of the strands 7 in the X direction. Depending on the measuring position and guidance of the strands 7, they move slightly in the Y direction, but can exhibit dynamic vibrations, especially in the feed area of the pelletizer. In production plants, dozens of parallel lines 7 often have to be measured. The background 4, which is at a similar temperature to the object temperature 26 and has different temperatures 25 in terms of location and, in this case, a temperature gradient field 48, allows the infrared sensors 1 to be placed relatively far away so that the measurement resolution of the infrared camera 1 can just about resolve the strands 7.

For the fluctuation evaluation it is sufficient, even with oscillations of the strands 7, that a strand width is imaged by only one or two pixels 47 and that all pixels 47 in partial coverage receive thermal radiation both from a strand 7 and from the background 4.

Due to the slow strand speed, the strand usually cools down along the direction of the stream of conveyed material 2. The information on the design of the gradient field described in detail in FIG. 7 must be observed for this application in particular.

For the requirement to measure the temperatures of individual strands 7 individually at a specified X-position, the background 4 can be divided into individually temperature-controlled portions in the Y-direction. This makes it possible to set the infrared contrast minimum for all strands 7 simultaneously in all portions very close to the specified X position despite temperature gradients along the strands 7 and different mean strand temperatures in a middle portion 4b.

It is also possible to define smaller portions 51a and 51b in the image in order to be able to determine the temperature for individual strands 7 in particular. As the position of the strands 7 is not always static, it is recommended to define portions 51 around respective strands or strand groups in the infrared image using classic image processing and, in particular, threshold value segmentation. The width of the portions 51 should be based on the respective width of the strands 7, so that a stable relative object area density can be maintained in each zone of each portion 51 for the fluctuation evaluation.

If the strand temperatures 26 are sufficiently stable in terms of time, there is a simpler method of determining the exact temperature of all individual strands 7 at a given X position. For this purpose, the mean background temperature 25 is increased and decreased in cycles for a background 4 with temperature gradient field 48 and a narrow evaluation portion 51 following the strand is defined for each strand 7 with a sensibly selected background area portion. Due to the variation of the background temperatures 25 in terms of time and location, the X-positions of the contrast minima shift with the mean background temperature 25 in all portions 51, so that object temperatures 39 determined for each strand are available for different X-positions. Regressions can be used to determine the longitudinal temperature gradient for each line 7. The respective measurement result of the determined strand temperature 39 at target measurement position X is calculated from the currently determined object temperature 39, the measurement position 41 of the fluctuation minimum, corrected by the product of the difference between the target and measurement position with the respective longitudinal temperature gradient of the strand 7.

FIG. 10 shows infrared sensors 1 on strands 7, similar to FIG. 8A, also optionally with an enclosure temperature control 22. However, the environmental conditions here are more difficult because the background 4 is immersed in a water bath 8 or is at least operated in a water bath or sprayed with water. Direct water contact with a heated background 4 will work reliably in the long term in very few system configurations. Deposits and flaking of deposits will cause an uncontrollable degree of emission from the heated surface, so that no reliable background infrared emission is possible.

The detailed view of the protective housing 10, which was specially developed for contact with water, shows that the temperature control apparatus 6 is thermally decoupled from the surrounding water in the form of a temperature-controlled beam. The heating and/or cooling element 21 mounted centrally inside the protective housing 10, which is controlled to a background temperature 25 by temperature sensor(s) 23, emits light through the infrared-transparent window 11 towards the infrared sensors 1 with the surface of the background 4. Infrared-transparent polymer films are known, cf. for example Garrett Beals, Gregory Balonek, Corrie Smeaton, and Joseph Sperry “Characterization of thin polymers for infrared windows”, Proc. SPIE 12103, Advanced Optics for Imaging Applications: UV through LWIR VII, 1210309 (27 May 2022); https://doi.org/10.1117/12.2618378, where reference is made to such infrared-transparent polymer films. These can be connected watertight to a suitably designed protective housing. Since the infrared transparent window 11 absorbs part of the radiation emitted by the background 4, the internally arranged temperature control apparatus 6 can be operated at a higher temperature, so that a background temperature 25 can be simulated according to the intensity evaluation of the infrared sensors 1. For an accurate measurement, the infrared sensors 1 can be calibrated with a calibration radiator in a comparable measuring arrangement. The temperature control for the temperature control apparatus 6 can then be determined using transfer calibration.

Although the temperature control apparatus 6 could be used to set a strand-specific background temperature radiation 25 by means of a large number of heating and/or cooling elements 21 in the transverse direction to the strands 7, this effort will hardly be relevant for practical application. It is easier to realize a temperature gradient field comparable to FIG. 9 as a background radiation field. The statistical contrast can already be determined with a single heating and/or cooling element 21, as in a column zone in FIG. 9, which can be characterized with a temperature frequency distribution. The frequency distribution can be used to determine whether the radiation emission from the background 4 is higher or lower than from the strands 7.

1. A method comprising:
contactlessly sensing a stream of conveyed material flowing past a background;
varying a temperature of the background in terms of time and/or location;
determining degrees of fluctuation of the temperature of the background based upon the contactlessly sensing;
determining a position of a minimum fluctuation from the degrees of fluctuation; and
determining an object temperature of an object in the stream of conveyed material based upon the minimum fluctuation.

2. The method of claim 1, wherein:
the method is for contactlessly determining the object temperature, being the temperature of a stranded and/or granular object in the stream of the conveyed material;
the contactlessly sensing comprises directing infrared sensors onto the stream of conveyed material flowing past the background;
a measurement signal from the infrared sensors is used in the determining of the object temperature;
varying the temperature of the background is via a temperature control apparatus;
determining the degrees of fluctuation is via an evaluation device and based on the measurement signal from the infrared sensors for different background temperatures; and
determining the object temperature comprises determining from the value of the measurement signal at the time and/or the location of the minimum fluctuation.

3. The method according to claim 2 further comprising:
subjecting the measurement signal to a regression analysis by a regression analysis module of the evaluation device;
determining by the regression analysis module a functional relationship between a change in the degree of fluctuation and the background temperature changing in terms of time and/or location; and
determining by the evaluation device the time and/or the location at which the fluctuation minimum occurs by means of the determined functional relationship;
wherein the determining of the object temperature is from the value of the measurement signal at the time and/or location of the fluctuation minimum determined from the functional relationship; and
wherein at least one of the background temperature, an averaged measurement signal or a reference temperature is used as a reference variable for the functional relationship of the degrees of fluctuation, whose value for a time and/or location zone with minimum degree of fluctuation corresponds as closely as possible to that of the background temperature and that of the infrared measurement signal, and for other time and/or location zones has a curve which is as linear as possible to the background temperature with a straight line gradient proportional to the difference between the background temperature and the object temperature.

4. The method according to claim 3, wherein a reference temperature is used as a reference variable for the regression analysis module and degrees of fluctuation for reference temperatures are determined and/or taken into account only above or only below the object temperature, so that the degree of fluctuation does not reach its minimum value and the determined object temperature is determined in extrapolation from the regression analysis model, and where the degree of fluctuation, being a fluctuation amplitude, approaches zero or becomes smaller than a predetermined minimum fluctuation threshold value.

5. The method according to claim 2 further comprising:
determining the time and/or location of the minimum fluctuation;
subjecting the measurement signal to a regression analysis by a regression analysis module of the evaluation device;
determining by the regression analysis module a functional relationship between a change in the degree of fluctuation and the background temperature changing in terms of time and/or location; and
determining by the evaluation device the time and/or the location at which the fluctuation minimum occurs by means of the determined functional relationship;
wherein the determining of the object temperature is from the value of the measurement signal at the time and/or location of the fluctuation minimum determined from the functional relationship;
wherein a data recording is used which comprises degrees of fluctuation, reference temperatures as well as the corresponding times and/or locations at different time and/or location evaluation zones; and
wherein contiguous data groups around minimum fluctuation values are filtered out, which have degrees of fluctuation smaller than a predetermined threshold value, and for each data group a regression of the time or the location against the reference temperature is carried out and for the respective data groups, the determined object temperature is inserted into a respectively determined regression equation, whereby the times and/or the locations of the minimum of fluctuation are determined.

6. The method according to claim 2 further comprising:
subjecting the measurement signal to a regression analysis by a regression analysis module of the evaluation device;
determining by the regression analysis module a functional relationship between a change in the degree of fluctuation and the background temperature changing in terms of time and/or location;
determining by the evaluation device the time and/or the location at which the fluctuation minimum occurs by means of the determined functional relationship; and
varying the background temperature in heating and cooling cycles;
wherein the determining of the object temperature is from the value of the measurement signal at the time and/or location of the fluctuation minimum determined from the functional relationship;
wherein a heating half-cycle begins with a background temperature below the object temperature, reaches it and then exceeds it, and is followed by a subsequent cooling half-cycle in which the initially high background temperature drops, then reaches the object temperature a further time in order to then fall below it again and return to the initial temperature;
wherein quasi-continuously in time and/or location evaluation zones which are limited to a temperature window for the background temperatures and/or averaged measurement signal values, fluctuation intensities and averaged background temperatures calculated for the same zones or averaged measurement signal values or reference temperatures are recorded in a data memory;
wherein one to two minima of the fluctuation intensities are further processed from the recorded data; and
wherein with each new recorded data set, the oldest recorded data set is no longer used for the evaluation and, when using the analysis regression model, an updated determined object temperature can be output with each measurement cycle.

7. The method according to claim 2 further comprising:
subjecting the measurement signal to a regression analysis by a regression analysis module of the evaluation device;
determining by the regression analysis module a functional relationship between a change in the degree of fluctuation and the background temperature changing in terms of time and/or location;
determining by the evaluation device the time and/or the location at which the fluctuation minimum occurs by means of the determined functional relationship; and
varying the background temperature in heating and cooling cycles by means of a temperature control apparatus so that the background temperature never reaches the object temperature;
wherein the determining of the object temperature is from the value of the measurement signal at the time and/or location of the fluctuation minimum determined from the functional relationship;
wherein quasi-continuously in the time and/or location evaluation zones which are limited to a temperature window for the background temperatures and/or averaged measurement signal values, fluctuation intensities and averaged background temperatures calculated for the same zones or averaged measurement signal values or reference temperatures are recorded in a data memory;
wherein values for fluctuation intensities for the lowest and highest background temperatures in the transitions between heating and cooling cycles are further processed from the recorded data, and when using the analysis regression model used in extrapolation, an updated determined object temperature is output with each measurement cycle.

8. A method comprising:
contactlessly sensing, with infrared sensors, a stream of conveyed material flowing past a background;
varying, with a temperature control apparatus, a temperature of the background in terms of time and/or location;
determining, by an evaluation device, degrees of fluctuation of the temperature of the background from a measurement signal from the infrared sensors for different background temperatures;
subjected the measurement signal to a regression analysis by a regression analysis module of the evaluation device;
determining by the regression analysis module, a functional relationship between a change in the degrees of fluctuation and a change in the background temperature in terms of time and/or location;
determining, by the evaluation device, the time and/or location at which a minimum fluctuation occurs by means of the determined functional relationship; and
determining an object temperature for each of one or more objects in the stream of conveyed material from the value of the measurement signal at the time and/or location of the minimum fluctuation determined from the functional relationship.

9. The method according to claim 8, wherein at least one of:
thermal radiation field of the background is changed in terms of time and/or location by the temperature control apparatus in such a way that at certain points in time and/or at at least one certain location, a thermal image of the background and of the stream of conveyed material flowing past the background provided by the infrared sensors is evaluated by an evaluation unit as at least approximately contrast-free, wherein the object temperature is determined from the location evaluated as contrast-free or the time evaluated as contrast-free; or
the background is temperature-controlled by the temperature control apparatus in such a way that a temperature gradient is generated along a conveying path of the stream of conveyed material according to which:
in a central portion of the background, the thermal radiation field of the background has a temperature which corresponds at least approximately to the object temperature, in an upstream portion the thermal radiation field has a temperature which is lower than the temperature in the central portion and in a downstream portion the thermal radiation field has a temperature which is greater than the temperature in the central portion of the background; or
in a central portion of the background, the thermal radiation field of the background has a temperature which corresponds at least approximately to the object temperature, in an upstream portion the thermal radiation field has a temperature which is greater than the temperature in the central portion and in a downstream portion the thermal radiation field has a temperature which is lower than the temperature in the central portion of the background.

10. The method according to claim 8, wherein, by means of the temperature control apparatus, the background temperature is increased and decreased in terms of time or location by a time or location average temperature; and
wherein the time or location average temperature is varied or adjusted in such a way that, at the average temperature, fluctuation amplitudes in the measurement signal approach zero.

11. The method according to claim 8, wherein a product guide in the form of a tube is used as the background, which is rotated about a longitudinal axis into a contrast measurement position, in which a contrast measurement with respect to the background is carried out by the infrared sensors; and
wherein the contrast measurement is carried out while the stream of conveyed material continues to flow or is stopped.

12. The method according to claim 8, wherein a measuring spot of the infrared sensors is entrained with the stream of conveyed material by means of a rotating prismatic mirror and/or is guided along in a direction of a conveying path of the stream of conveyed material against the background.

13. The method according to claim 12, wherein the rotational speed of the prism mirror is readjusted on the basis of an image evaluation in such a way that the average size of the objects imaged in the thermal image of the infrared sensors is minimized and/or minimal afterglow tails occur towards a front and rear, so that a single-object temperature measurement is undertaken and, if necessary, statistical statements are made about the temperature homogeneity of the product stream; and
wherein the measuring spot is moved at a highly dynamically varying angular speed of the prism mirror at a scanning speed which is at least nearly constant.

14. The method according to claim 8, wherein the infrared sensors are used to determine the object temperatures and the positions of the fluctuation minima along a conveying path of the stream of conveyed material in a plurality of measuring portions, in order to measure temperature changes and the path-related rate of temperature change of the objects from a plurality of measurements along a direction of the stream of conveyed material.

15. The method according to claim 8, wherein a temperature field of the background, which varies in terms of location, is also varied in terms of time, and both the positions of the fluctuation minimum along a direction of the stream of conveyed material and the object temperatures determined at these locations are recorded for the objects, so that the path-related temperature change rate of the objects is determined from a resulting point cloud.

16. The method according to claim 8, wherein for individual measurement of the object temperatures of objects being strands, an infrared image is segmented using image processing and individual evaluation portions are defined for individual strands or groups of adjacent strands; and
wherein an object temperature is determined for each portion and/or, with additional variation of the background in terms of time, temperature gradients in a longitudinal direction of the strand are also determined.

17. The method according to claim 8, wherein a plurality of measuring spots, which are distributed in a direction of the stream of conveyed material, are captured simultaneously or successively by the infrared sensors by means of a plurality of sensor elements or a sensor element row or matrix.

18. The method according to claim 8, wherein the locations and/or times in which objects do not have contrast with respect to the background are used to determine a temperature compensation of the infrared sensors.

19. The method according to claim 8, wherein the infrared sensors are operated by means of an active temperature control apparatus under fluctuating ambient conditions in a predetermined temperature window which is kept constant irrespective of ambient conditions.

20. The method according to claim 8, wherein the infrared sensors are repositioned in a calibration step from an intended measuring position on the background to a calibration station with an at least approximately black emitter whose temperature in a measuring spot is regulated to an operating point temperature relevant for the objects to be measured.

21. An apparatus for non-contact temperature measurement of strand-shaped or granule-shaped objects of a stream of conveyed material comprising:
infrared sensors for capturing the radiation field of the stream of conveyed material flowing past against a background;
a temperature control apparatus for controlling the temperature of the background wherein, conditions for measurement under specular inclusion can be produced through an environment; and
an evaluation device for evaluating the measurement signal from the infrared sensors and determining the object temperature from the measurement signal;
wherein the temperature control apparatus is configured to vary the temperature of the background in terms of time and/or location; and
wherein, in the measurement signal from the infrared sensors captured at a varying background temperature, the evaluation device is configured to evaluate a degree of fluctuation of signal fluctuations and to determine the time and/or location of a fluctuation minimum and to determine the determined object temperature from the value of the measurement signal at the time/location of the fluctuation minimum.

22. The apparatus according to claim 21, wherein the evaluation device has a regression analysis module that is suitable for establishing, by regression analysis, a functional relationship between the degree of fluctuation, and time or location, from which the time or location at which the fluctuation minimum occurs can be determined.

23. The apparatus according to claim 22, wherein, in the evaluation device, there are defined boundaries for time and/or location evaluation zones with presumably very similar background temperatures, which are characterized by background temperatures within a temperature window or time window or image area regions;
wherein the evaluation device is configured to calculate and at least temporarily store data for a subsequent analysis for the evaluation zones selected from the group consisting of:
a degree of fluctuation transformed, if necessary, of the measurement signal, which is quantified by evaluating the amplitude, the range, a trimmed range and/or the standard deviation;
a representative temperature reference value selected or calculated by averaging or filtering for the respective evaluation zone, whose value for a time and/or location zone with minimum fluctuation corresponds as closely as possible to that of the background temperature and that of the measurement signal, and for other time and/or location zones has a curve which is as linear as possible to the background temperature with a straight line gradient proportional to the difference between the background temperature and the object temperature;
a value selected for the time or calculated by averaging or filtering to be representative of the respective evaluation zone, wherein the average value of the start and end times of the data recording for the respective evaluation zone;
a value selected for the time or calculated by suitable averaging or filtering, or a plurality of values which are kept for later precise location analysis, and/or contour lines delimiting the evaluation zone; and
a combination thereof.

24. The apparatus according to claim 21, wherein the temperature control apparatus is configured to generate a temperature gradient along a conveying path of the stream of material to be conveyed, according to which:
in a central portion of the background, the thermal radiation field of the background has a temperature which corresponds at least approximately to the object temperature, in an upstream portion the thermal radiation field has a temperature which is lower than the temperature in the central portion and in a downstream portion the thermal radiation field has a temperature which is greater than the temperature in the central portion of the background; or
in a central portion of the background, the thermal radiation field of the background has a temperature which corresponds at least approximately to the object temperature, in an upstream portion the thermal radiation field has a temperature which is greater than the temperature in the central portion and in a downstream portion the thermal radiation field has a temperature which is lower than the temperature in the central portion of the background.

25. The apparatus according to claim 21, wherein a product guide in the form of a tube is provided as the background, which can be rotated about a longitudinal axis into a contrast measurement position.

26. The apparatus according to claim 21, wherein in regions of the environment which can be indirectly captured by the infrared sensors via reflections in the specular angle on surfaces of the objects, emit slightly more infrared radiation through an enclosure temperature control than infrared radiation of the objects with the determined object temperature, so that infrared radiation losses in edge zones and a measuring aperture are compensated and measuring conditions of the specular inclusion can be produced in a measuring zone in good approximation, which minimize the influence of an infrared degree of emission ε of the objects.

27. The apparatus according to claim 21, wherein the background and/or an inner wall of the enclosure temperature control is provided with a coating having a degree of emission with respect to infrared radiation of more than 40%.

28. The apparatus according to claim 27, wherein the background and/or the inner wall of the enclosure temperature control is provided with a non-stick coating of fluoropolymers or silicones; and
wherein the non-stick coating has a degree of emission with respect to infrared radiation of more than 80%.

29. The apparatus according to claim 21, wherein the infrared sensors comprise a plurality of measuring spots along a conveying path of the stream of conveyed material and/or local object temperatures can be determined in a plurality of evaluation portions.

30. The apparatus according to claim 21, wherein the infrared sensors comprise a rotating prismatic mirror for entraining a measuring spot with the stream of conveyed material and/or guiding the measuring spot along a direction of the conveying path of the stream of conveyed material against the background.

31. The apparatus according to claim 30, wherein a control device for controlling a rotational speed of the prism mirror based on an image evaluation is designed in such a manner that an average size of the objects imaged in a thermal image of the infrared sensors is minimized and/or minimal afterglow tails occur towards a front and rear, and/or the measuring spot is moved at a highly dynamically varying angular speed of the prism mirror at a scanning speed which is at least nearly constant.

32. The apparatus according to claim 21, wherein the infrared sensors comprise a plurality of sensor elements or a sensor element row or matrix with a plurality of measuring spots distributed in a direction of the stream of conveyed material.

33. The apparatus according to claim 21, wherein a water temperature control sleeve around a sensor head is provided for controlling the temperature of the infrared sensors also under fluctuating ambient conditions in a predetermined temperature window which is kept constant irrespective of ambient conditions.

34. A pelletizing apparatus for pelletizing objects comprising:
the apparatus according to claim 21.

35. The pelletizing apparatus according to claim 34 further comprising:
an underwater pelletizer; and
a pellet dryer arranged downstream of the underwater pelletizer;
wherein the infrared sensors of the apparatus are directed towards the stream of conveyed material being in a dryer outlet of the pellet dryer.

36. The pelletizing apparatus according to claim 34 further comprising:
a strand pelletizing head for producing the objects in the form of strands;
wherein the infrared sensors of the apparatus are directed towards the strands exiting the strand pelletizing head for contactlessly determining the temperature of the strands.

37. The pelletizing apparatus according to claim 36, wherein the temperature control apparatus of the apparatus is configured to control the temperature of the background behind the strands guided in or flowed around by water only in a narrow transverse strip such that a sensor-weighted infrared emission corresponds to that of a required background temperature.

38. The method according to claim 15, wherein the path-related temperature change rate of the objects is determined from linear regression.

39. The method according to claim 19, wherein the active temperature control apparatus comprises a water temperature control sleeve around a sensor head.

40. The method according to claim 20, wherein:
the repositioning takes place without interrupting power supply and temperature control;

41. The method according to claim 40, wherein:
the calibration step comprises sub-steps including initially directing the infrared sensors at the black emitter of the calibration station and the infrared sensors calibrated to the relevant operating point by means of a first parallel measurement of the measurement signal and a calibration reference temperature, and a transfer calibration performed on the background.

42. The method according to claim 41, wherein:
during the transfer calibration performed on the background, the background is set at least approximately stable to the same operating temperature of the black emitter, wherein a second parallel measurement is then undertaken with the infrared sensors repositioned to the intended measuring position, in which infrared radiation of the background is simultaneously measured and the background temperature is measured with a contacting temperature sensor, wherein a degree of emission of a temperature-controlled background environment is determined from the results of the second parallel measurement as a near-black emitter and stored as a calibration parameter for the operating point temperature.
